(19) United States
(12) Patent Application Publication
(10) Pub. No.: US 2026/0331016 A1
(43) Pub. Date: Oct. 22, 2026

(54) PIXEL CIRCUIT, ARRAY SUBSTRATE, AND DISPLAY PANEL

(71) Applicant: Beijing Visionox Technology Co., Ltd., Beijing (CN)

(72) Inventors: Cuili GAI, Beijing (CN); Enqing GUO, Beijing (CN); Jianjun LU, Beijing (CN)

(73) Assignee: Beijing Visionox Technology Co., Ltd., Beijing (CN)

(21) Appl. No.: 19/696,258

(22) Filed: Jun. 2, 2026

(30) Foreign Application Priority Data
Jul. 31, 2025 (CN) 202511075030.3

(51) Int. Cl. G09G 3/20

(52) U.S. Cl. CPC G09G 3/20; G09G 2300/0819; G09G 2300/0852; G09G 2300/0861; G09G 2310/0286; G09G 2310/08; G09G 2320/0233; G09G 2320/0257; G09G 2330/02

(57) ABSTRACT

The present disclosure discloses a pixel circuit, an array substrate, and a display panel. In a first initialization phase, a first initialization module transmits a first initialization voltage from a first initialization signal line to a control terminal of a driving module. A first terminal of the driving module receives a predetermined fixed voltage, and a voltage value of the predetermined fixed voltage is greater than a voltage value of the first initialization voltage. This creates a voltage difference between the first terminal and the control terminal of the driving module during the first initialization phase, thereby recovering threshold voltage drift of the driving module, improving afterimage issues in displayed images, and enhancing image display quality. In a compensation phase, a compensation module transmits voltage information related to a threshold voltage of the driving module to the control terminal of the driving module.

### CROSS-REFERENCE TO RELATED APPLICATION

This application claims priority to Chinese Patent Application No. 202511075030.3 filed Jul. 31, 2025, the disclosure of which is incorporated herein by reference in its entirety.

### FIELD

The present disclosure relates to the field of display technology, and in particular, to a pixel circuit, an array substrate, and a display panel.

### BACKGROUND

With the development of display technology, users have increasingly higher requirements for the picture display quality of display panels.

However, in the prior art, display panels still have the problem of poor picture display quality, which affects user experience.

### SUMMARY

The present disclosure provides a pixel circuit, an array substrate, and a display panel to improve the picture display quality of the display panel and enhance user experience.

According to one aspect of the present disclosure, a pixel circuit is provided, including:
a driving module, a first terminal of the driving module being configured to input a predetermined fixed voltage, and a second terminal of the driving module outputting a driving current;
a first initialization module, a first terminal of the first initialization module being connected to a first initialization signal line, a second terminal of the first initialization module being connected to a control terminal of the driving module, the first initialization module being configured to, during a first initialization phase, transmit a first initialization voltage from the first initialization signal line to the control terminal of the driving module, a voltage value of the predetermined fixed voltage being greater than a voltage value of the first initialization voltage, and a voltage at the control terminal of the driving module is lower than a voltage at the first terminal of the driving module, to improve characteristics of the driving module;
a compensation module, the compensation module being connected between the second terminal of the driving module and the control terminal of the driving module, and being configured to, during a compensation phase, transmit voltage information related to a threshold voltage of the driving module to the control terminal of the driving module, to improve characteristics of the driving module; the first initialization phase precedes the compensation phase.

According to another aspect of the present disclosure, an array substrate is provided, including the pixel circuit according to any embodiment of the present disclosure.

According to another aspect of the present disclosure, a display panel is provided, including the array substrate according to any embodiment of the present disclosure.

In the embodiments of the present disclosure, during the first initialization phase, the first initialization module transmits the first initialization voltage on the first initialization signal line to the control terminal of the driving module, the first terminal of the driving module receives the predetermined fixed voltage, and the voltage value of the predetermined fixed voltage is greater than the voltage value of the first initialization voltage, and during the first initialization phase, a voltage difference exists between the first terminal and the control terminal of the driving module, recovering threshold voltage drift of the driving module, improving characteristics of the driving module, thereby improving the afterimage problem of the display picture and enhancing picture display quality.

Moreover, during the compensation phase, the compensation module transmits voltage information related to the threshold voltage of the driving module to the control terminal of the driving module, during the compensation phase. The voltage information may be equal to the threshold voltage, or not equal to, but required by calculating on the base of the threshold voltage. The driving module is turned on and generates a driving current, recovering threshold voltage drift of the driving module, improving characteristics of the driving module, which is also beneficial for improving afterimage and further enhancing picture display quality. Additionally, during the compensation phase, compensation is performed for the threshold voltage of the driving module, which is beneficial for improving the poor display uniformity caused by inconsistent threshold voltages of driving modules in different pixel circuits in the display panel, further improving picture display quality and enhancing display effect.

The content described in this section is not intended to identify key or essential features of the embodiments of the present disclosure, nor is it intended to limit the scope of the present disclosure. Other features of the present disclosure will become readily understandable through the following description.

### BRIEF DESCRIPTION OF THE DRAWINGS

FIG. 1 is a schematic structural diagram of a pixel circuit provided by an embodiment of the present disclosure;

FIG. 2 is a schematic structural diagram of another pixel circuit provided by an embodiment of the present disclosure;

FIG. 3 is a schematic structural diagram of another pixel circuit provided by an embodiment of the present disclosure;

FIG. 4 is a schematic structural diagram of another pixel circuit provided by an embodiment of the present disclosure;

FIG. 5 is a schematic structural diagram of yet another pixel circuit provided by an embodiment of the present disclosure;

FIG. 6 is a schematic structural diagram of another pixel circuit provided by an embodiment of the present disclosure;

FIG. 7 is a schematic structural diagram of yet another pixel circuit provided by an embodiment of the present disclosure;

FIG. 8 is a schematic structural diagram of still another pixel circuit provided by an embodiment of the present disclosure;

FIG. 9 is a schematic structural diagram of another pixel circuit provided by an embodiment of the present disclosure;

FIG. 10 is a driving timing diagram of a pixel circuit provided by an embodiment of the present disclosure;

FIG. 11 is a driving timing diagram of another pixel circuit provided by an embodiment of the present disclosure;

FIG. 12 is a driving timing diagram of a pixel circuit in a write frame provided by an embodiment of the present disclosure;

FIG. 13 is a driving timing diagram of a pixel circuit in a hold frame provided by an embodiment of the present disclosure;

FIG. 14 is a driving timing diagram of another pixel circuit in a hold frame provided by an embodiment of the present disclosure;

FIG. 15 is a driving timing diagram of another pixel circuit in a write frame provided by an embodiment of the present disclosure;

FIG. 16 is a driving timing diagram of another pixel circuit in a hold frame provided by an embodiment of the present disclosure;

FIG. 17 is a driving timing diagram of another pixel circuit in a hold frame provided by an embodiment of the present disclosure;

FIG. 18 is a schematic structural diagram of another pixel circuit provided by an embodiment of the present disclosure;

FIG. 19 is a schematic structural diagram of another pixel circuit provided by an embodiment of the present disclosure;

FIG. 20 is a schematic structural diagram of an array substrate provided by an embodiment of the present disclosure;

FIG. 21 is a schematic structural diagram of a display panel provided by an embodiment of the present disclosure.

### DETAILED DESCRIPTION

In the related art, display panels still have the problem of poor picture display quality, which affects user experience. In existing display panels, problems such as image sticking and poor uniformity exist, affecting the picture display quality of the display panel.

To improve the picture display quality of the display panel, an embodiment of the present disclosure provides a pixel circuit. FIG. 1 is a schematic structural diagram of a pixel circuit provided by an embodiment of the present disclosure. Referring to FIG. 1, the pixel circuit includes: a driving module 110, a first terminal of the driving module 110 is configured to receive a predetermined fixed voltage V0, and a second terminal of the driving module 110 outputs a driving current; a first initialization module 120, a first terminal of the first initialization module 120 is connected to a first initialization signal line Vref1, a second terminal of the first initialization module 120 is connected to a control terminal G1 of the driving module 110, and the first initialization module 120 is configured to, in a first initialization phase, transmit a first initialization voltage from the first initialization signal line Vref1 to the control terminal G1 of the driving module 110.

A voltage value of the predetermined fixed voltage V0 is greater than a voltage value of the first initialization voltage, and a voltage at the control terminal G1 of the driving module 110 is lower than a voltage at the first terminal of the driving module 110, thereby improving characteristics of the driving module 110; a compensation module 130, the compensation module 130 is connected between the second terminal of the driving module 110 and the control terminal G1 of the driving module 110, and is configured to, in a compensation phase, transmit voltage information related to a threshold voltage of the driving module 110 to the control terminal G1 of the driving module 110, thereby improving characteristics of the driving module 110; the first initialization phase precedes the compensation phase.

In one embodiment, the first terminal of the driving module 110 may be directly connected to a predetermined fixed voltage V0, or indirectly connected to the predetermined fixed voltage V0. In the case where the first terminal of the driving module 110 is directly connected to the fixed voltage, the driving module 110 may be connected to the predetermined fixed voltage V0 through a conductive signal line, and the predetermined fixed voltage V0 is directly input to the first terminal of the driving module 110 via the conductive signal line. In the case where the first terminal of the driving module 110 is indirectly connected to the predetermined fixed voltage V0, the first terminal of the driving module 110 may be connected to the predetermined fixed voltage V0 through a switching device, which may be, in an embodiment, a thin-film transistor.

When the switching device is turned on, the predetermined fixed voltage V0 is transmitted to the first terminal of the driving module 110. The driving module 110 further includes a control terminal. The driving module 110 may be turned on or off according to the voltage difference between its own control terminal and the first terminal. When the driving module 110 is turned on, the second terminal of the driving module 110 outputs a driving current; when the driving module 110 is turned off, the second terminal of the driving module 110 does not output a driving current.

The pixel circuit further includes a first initialization module 120. The first initialization module 120 is connected to a first initialization signal line Vref1 and the control terminal G1 of the driving module 110, respectively. The connection between the first initialization module 120 and the control terminal G1 of the driving module 110 may be a direct connection or an indirect connection. In the case of a direct connection between the first initialization module 120 and the control terminal G1 of the driving module 110, the second terminal of the first initialization module 120 and the control terminal G1 of the driving module 110 may be connected via a conductive signal line. In the case of an indirect connection between the first initialization module 120 and the control terminal G1 of the driving module 110, a switching device may be included between the second terminal of the first initialization module 120 and the control terminal G1 of the driving module 110.

The switching device may be, in an embodiment, a thin-film transistor. When the switching device is turned on, the second terminal of the first initialization module 120 is connected to the control terminal G1 of the driving module 110. In this embodiment, during the first initialization phase, the first initialization module 120 is turned on, transmitting the first initialization voltage from the first initialization signal line Vref1 to the control terminal G1 of the driving module 110.

Simultaneously, during the first initialization phase, the first terminal of the driving module 110 is connected to the predetermined fixed voltage V0, and the voltage value of the predetermined fixed voltage V0 is greater than the voltage value of the first initialization voltage.

This ensures that during the first initialization phase, the voltage at the control terminal G1 of the driving module 110 is lower than the voltage at the first terminal of the driving module 110, creating a voltage difference between the first terminal and the control terminal G1 of the driving module 110. This results in a voltage bias between the first terminal and the control terminal G1 of the driving module 110, providing voltage stress to the driving module 110, thereby restoring and improving the characteristics of the driving module 110. In an embodiment, it recovers the threshold voltage drift of the driving transistor within the driving module 110, thereby improving the afterimage issue in the display image and enhancing the display quality.

In an embodiment, the driving transistor is a P-type transistor. If the display image of the previous frame on the display panel is a black image and the driving transistor is in the off state, the voltage at the gate of the driving transistor (i.e., the control terminal G1 of the driving module 110) in the previous frame is relatively high. In an embodiment, the voltage difference between the gate and the source of the driving transistor is positive, or greater than the negative value of the threshold voltage of the driving transistor, causing the threshold voltage of the driving transistor to drift.

By transmitting the first initialization voltage to the control terminal G1 of the driving module 110 through the first initialization module 120 during the first initialization phase, and connecting the first terminal of the driving module 110 to the predetermined fixed voltage V0, where the voltage value of the predetermined fixed voltage V0 is greater than the voltage value of the first initialization voltage, the gate voltage of the driving transistor during the first initialization phase becomes relatively low. The gate-source voltage difference of the driving transistor during the first initialization phase is a relatively large negative value (less than the negative value of the threshold voltage of the driving transistor), creating a significant voltage bias between the first terminal and the control terminal G1 of the driving module 110.

This recovers the threshold voltage drift of the driving transistor, improves the characteristics of the driving transistor, and thereby mitigates the afterimage phenomenon in black images. The pixel circuit further includes a compensation module 130. The compensation module 130 is connected between the second terminal of the driving module 110 and the control terminal G1 of the driving module 110, meaning the compensation module 130 is connected to both the second terminal of the driving module 110 and the control terminal G1 of the driving module 110. During the compensation phase, the driving module 110 and the compensation module 130 are turned on, transmitting voltage information related to the threshold voltage of the driving module 110 to the control terminal G1 of the driving module 110 to compensate for the threshold voltage of the driving module 110. This helps improve the poor display uniformity caused by inconsistent threshold voltages of the driving modules 110 in different pixel circuits within the display panel, enhances the display quality, and improves the display effect. The driving module 110 may include a driving transistor, and the threshold voltage of the driving module 110 is the threshold voltage of the driving transistor. Since the driving module 110 is turned on during the compensation phase and generates a driving current, current stress exists in the driving module 110 during this phase, thereby restoring and improving the characteristics of the driving module 110.

In an embodiment, it solves the problem of the threshold voltage drift of the driving transistor within the driving module 110, which also helps improve afterimage and further enhances the display quality. In an embodiment, the driving transistor is a P-type transistor. If the display image of the previous frame on the display panel is a white image, the voltage at the gate of the driving transistor (i.e., the control terminal G1 of the driving module 110) in the previous frame is relatively low, and the voltage difference between the first terminal and the gate of the driving transistor is relatively large, causing the threshold voltage of the driving transistor to drift (the drift direction of the threshold voltage may be opposite to that when the previous frame is a black image). By turning on the driving module 110 during the compensation phase, the driving module 110 generates a driving current. During this phase, current stress exists in the driving module 110, solving the threshold voltage drift of the driving transistor, improving the characteristics of the driving transistor, and thereby mitigating the afterimage phenomenon in white images.

In the pixel circuit of this embodiment, during the first initialization phase, the first initialization module transmits the first initialization voltage from the first initialization signal line to the control terminal of the driving module. The first terminal of the driving module is connected to a predetermined fixed voltage, and the voltage value of the predetermined fixed voltage is greater than that of the first initialization voltage. This creates a voltage difference between the first terminal and the control terminal of the driving module during the first initialization phase, thereby recovering the threshold voltage drift of the driving module, improving the characteristics of the driving transistor, and consequently mitigating the image retention issue in the display, enhancing image display quality. Furthermore, during the compensation phase, the compensation module transmits voltage information related to the threshold voltage of the driving module to its control terminal.

During this phase, the driving module is turned on and generates a driving current, which also helps recover the threshold voltage drift of the driving module, improves the characteristics of the driving transistor, similarly contributes to reducing image retention, and further enhances image display quality. Additionally, compensating for the threshold voltage of the driving module during the compensation phase helps address the poor display uniformity caused by threshold voltage inconsistencies among the driving modules of different pixel circuits in the display panel, further improving image display quality and enhancing the display effect.

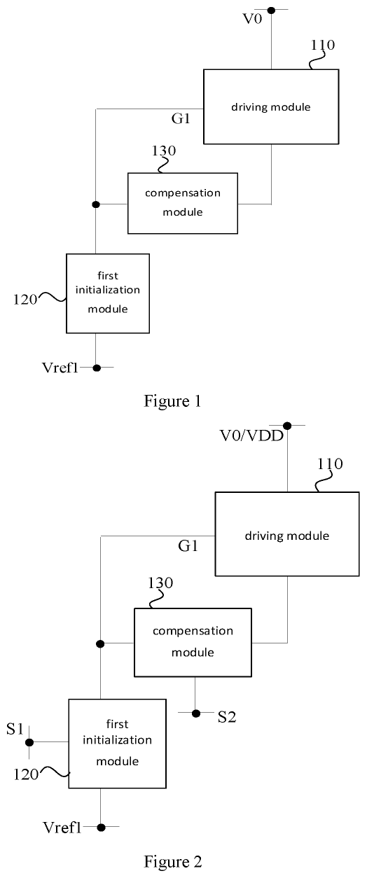

FIG. 1 is a schematic structural diagram of another pixel circuit provided by an embodiment of the present disclosure. Referring to FIG. 2, in an embodiment, the first terminal of the driving module 110 is connected to the first power line VDD, and the predetermined fixed voltage V0 is equal to the first power voltage on the first power line VDD. In this pixel circuit, the first terminal of the driving module 110 is directly connected to the predetermined fixed voltage V0. With this configuration, no switching device is required between the first terminal of the driving module 110 and the first power line VDD, which can reduce the number of components in the pixel circuit and is beneficial for increasing pixel density. Continuing to refer to FIG. 2, in an embodiment, the control terminal of the first initialization module 120 is connected to the first scan signal line S1. During the first initialization phase, in response to the first scan signal on the first scan signal line S1, it transmits the first initialization voltage to the control terminal G1 of the driving module 110. In one embodiment, during the first initialization phase, the first scan signal is at an active level. The first initialization module 120 turns on in response to the active level of the first scan signal and transmits the first initialization voltage to the control terminal G1 of the driving module 110, thereby initializing the control terminal G1 of the driving module 110. Here, the first initialization voltage is much lower than the first power voltage. In an embodiment, the first initialization voltage is less than 0, and the first power voltage is greater than 0. In an embodiment, the first initialization voltage is −7V, and the first power voltage is +7V.

This results in a large voltage difference between the first terminal and the control terminal of the driving module 110 during the first initialization phase, creating a significant voltage bias between them, which further helps improve image retention. The active level of the first scan signal is the level that turns on the first initialization module 120, and the inactive level is the level that turns off the first initialization module 120. In an embodiment, the first initialization module 120 may include a first transistor, which can be either a P-type transistor or an N-type transistor. In an embodiment, if the first transistor is a P-type transistor, the active level of the first scan signal is a low level, and the inactive level is a high level. If the first transistor is an N-type transistor, the active level of the first scan signal is a high level, and the inactive level is a low level.

In an embodiment, the control terminal of the compensation module 130 is connected to the second scan signal line S2. The first terminal of the compensation module 130 is connected to the second terminal of the driving module 110, and the second terminal of the compensation module 130 is connected to the control terminal G1 of the driving module 110. During the compensation phase, based on the first power voltage, it transmits voltage information related to the threshold voltage of the driving module 110 to the control terminal G1 of the driving module 110.

In one embodiment, during the compensation phase, the second scan signal is at an active level. The compensation module 130 turns on, and the driving module 110 also turns on. Based on the first power voltage, the control terminal G1 of the driving module 110 is charged through the driving module 110 and the compensation module 130 until the voltage at the control terminal G1 of the driving module 110 equals the sum of the first power voltage and the threshold voltage of the driving module 110, thereby compensating for the threshold voltage of the driving module 110. That is, for the structure of the pixel circuit shown in FIG. 2, the information related to the threshold voltage of the driving module 110 is equal to the sum of the first power voltage and the threshold voltage of the driving module 110.

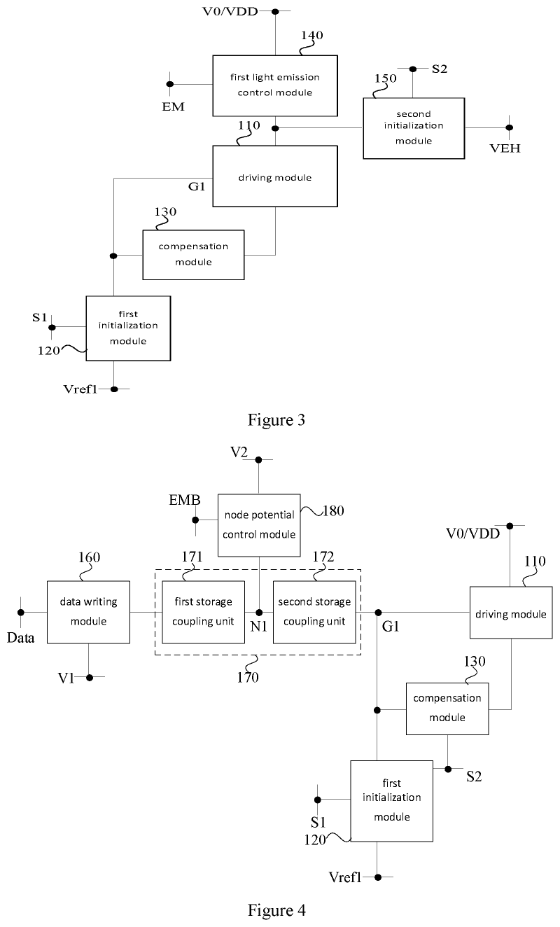

FIG. 2 is a schematic structural diagram of another pixel circuit provided by an embodiment of the present disclosure. Referring to FIG. 3, in this pixel circuit, the first terminal of the driving module 110 is indirectly connected to the predetermined fixed voltage V0. In an embodiment, the pixel circuit further includes a first light emission control module 140 and a second initialization module 150. The control terminal of the first light emission control module 140 is connected to the first light emission control signal line EM. The first terminal of the first light emission control module 140 is connected to the first power line VDD, and its second terminal is connected to the first terminal of the driving module 110. The first light emission control module 140 is used to turn on during the light emission phase in response to the active level of the first light emission control signal on the first light emission control signal line EM.

The control terminal of the second initialization module 150 is connected to the second scan signal line S2. The first terminal of the second initialization module 150 is connected to the second power line VEH, and its second terminal is connected to the first terminal of the driving module 110. The second initialization module 150 is used during the compensation phase, in response to the active level of the second scan signal on the second scan signal line S2, to transmit the second power voltage from the second power line VEH to the first terminal of the driving module 110.

The compensation module 130 is used during the compensation phase, based on the second power voltage, to transmit voltage information related to the threshold voltage of the driving module 110 to the control terminal G1 of the driving module 110. In the pixel circuit of this embodiment, the first terminal of the driving module 110 is connected to the first light emission control module 140 and the second initialization module 150. This circuit structure is suitable for wide-frequency driving scenarios.

In one embodiment, a first terminal of the driving module 110 is connected to a first power supply voltage on a first power supply line VDD through a first light emission control module 140, and the first terminal of the driving module 110 is connected to a second power supply voltage on a second power supply line VEH through a second initialization module 150. For the pixel circuit shown in FIG. 3, when the first light emission control module 140 is turned on and the second initialization module 150 is turned off, the first terminal of the driving module 110 is connected to the first power supply voltage, and at this time, a fixed voltage V0 is set equal to the first power supply voltage. In one embodiment, the first light emission control module 140 is turned on in response to an active level of a first light emission control signal on a first light emission control signal line EM during a light emission phase, and the first power supply voltage is transmitted to the first terminal of the driving module 110 through the first light emission control module 140. When the first light emission control module 140 is turned off and the second initialization module 150 is turned on, the first terminal of the driving module 110 is connected to the second power supply voltage, and at this time, the fixed voltage V0 is set equal to the second power supply voltage.

In one embodiment, during a compensation phase, the second initialization module 150 transmits the second power supply voltage on the second power supply line VEH to the first terminal of the driving module 110 in response to an active level of a second scan signal on a second scan signal line S2; during the compensation phase, the second initialization module 150, the driving module 110, and a compensation module 130 are turned on, and the control terminal G1 of the driving module 110 is charged through the second initialization module 150, the driving module 110, and the compensation module 130 until a voltage at the control terminal G1 of the driving module 110 equals a sum of the second power supply voltage and a threshold voltage of the driving module 110, that is, for the pixel circuit shown in FIG. 3, voltage information related to the threshold voltage of the driving module 110 equals an absolute value of the second power supply voltage and the threshold voltage of the driving module 110. Continuing to refer to FIG. 3, a control terminal of a first initialization module 120 is connected to a first scan signal line S1, and is configured to transmit a first initialization voltage to the control terminal G1 of the driving module 110 in response to a first scan signal in the first scan signal line S1 during a first initialization phase. The first initialization voltage is much smaller than the second power supply voltage, in an embodiment, the first initialization voltage is less than 0, and the second power supply voltage is greater than 0.

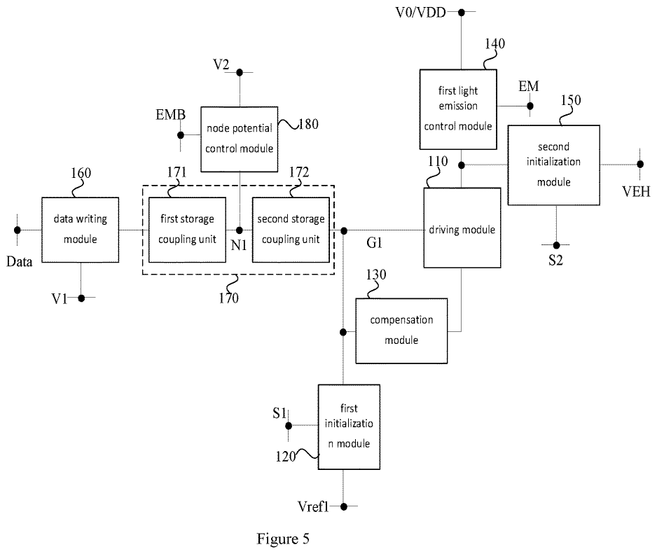

During the first initialization phase, a voltage difference between the first terminal and the control terminal of the driving module 110 is relatively large, resulting in a significant voltage bias between the first terminal and the control terminal of the driving module 110, thereby further improving afterimage. FIG. 4 is a schematic structural diagram of another pixel circuit provided by an embodiment of the present disclosure, and FIG. 5 is a schematic structural diagram of yet another pixel circuit provided by an embodiment of the present disclosure; FIG. 4 is based on the pixel circuit structure shown in FIG. 2, and FIG. 5 is based on the pixel circuit structure shown in FIG. 3.

Referring to FIG. 4 and FIG. 5, in an embodiment, the pixel circuit further includes: a data writing module 160, and the data writing module 160 is connected to a data line Data and a first fixed voltage line, respectively; a storage coupling module 170, and a first terminal of the storage coupling module 170 is connected to the data writing module 160, and a second terminal of the storage coupling module 170 is connected to the control terminal G1 of the driving module 110; the data writing module 160 is configured to transmit a data voltage on the data line Data to the first terminal of the storage coupling module 170 during a data writing phase, and to transmit a first fixed voltage V1 on the first fixed voltage line to the first terminal of the storage coupling module 170 during a light emission phase; the storage coupling module 170 is configured to couple a voltage containing data voltage information from the first terminal of the storage coupling module 170 to the control terminal G1 of the driving module 110 during the light emission phase, and the driving module 110 is configured to generate a driving current according to a voltage at the control terminal G1 of the driving module 110 during the light emission phase; a node potential control module 180, and the node potential control module 180 is connected to a first internal node N1 of the storage coupling module 170, and a control terminal of the node potential control module 180 is connected to a first control signal line EMB, and is configured to transmit a second fixed voltage V2 to the first internal node N1 during an initialization phase, a compensation phase, and the data writing phase under control of a first control signal in the first control signal line EMB.

In one embodiment, during the data writing phase, the data writing module 160 transmits the data voltage to the first terminal of the storage coupling module 170; during the light emission phase, the data writing module 160 transmits the first fixed voltage V1 to the first terminal of the storage coupling module 170. During the data writing phase, the node potential control module 180 transmits the second fixed voltage V2 to the first internal node N1, and during a period between the data writing phase and the light emission phase, the node potential control module 180 remains turned on, and the first internal node N1 is maintained at the second fixed voltage V2, thereby preventing the potential of the first internal node N1 from changing with the potential of the first terminal of the storage coupling module 170 before the light emission phase.

During the light emission phase, the node potential control module 180 is turned off, the data writing module 160 transmits the first fixed voltage V1 to the first terminal of the storage coupling module 170, the potential of the first terminal of the storage coupling module 170 changes from the data voltage to the first fixed voltage V1, and the storage coupling module 170 couples a voltage containing data voltage information to the control terminal G1 of the driving module 110. In one embodiment, a voltage change at the control terminal G1 of the driving module 110 may equal a voltage change at the first terminal of the storage coupling module 170, that is, a difference between the first fixed voltage V1 and the data voltage. In this embodiment, the data writing module 160 can write voltage information related to the data voltage to the control terminal G1 of the driving module 110 through the storage coupling module 170, without needing to write the data voltage to the control terminal G1 of the driving module 110 through the driving module 110 and the compensation module 130.

In one embodiment, the data writing phase and the compensation phase can be separated, which is beneficial for improving refresh rate on one hand, and on the other hand, allows for sufficient compensation of the threshold voltage of the driving module 110, thereby enhancing display performance.

Continuing to refer to FIG. 4 and FIG. 5, in an embodiment, the storage coupling module 170 includes a first storage coupling unit 171 and a second storage coupling unit 172. A first terminal of the first storage coupling unit 171 serves as a first terminal of the storage coupling module 170. A second terminal of the first storage coupling unit 171 is connected to a first terminal of the second storage coupling unit 172 at a first internal node N1. A second terminal of the second storage coupling unit 172 is electrically connected to a control terminal G1 of the driving module 110.

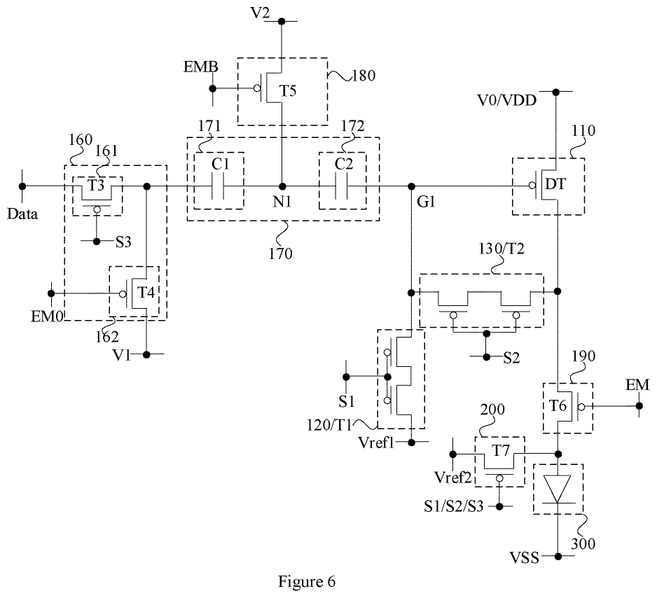

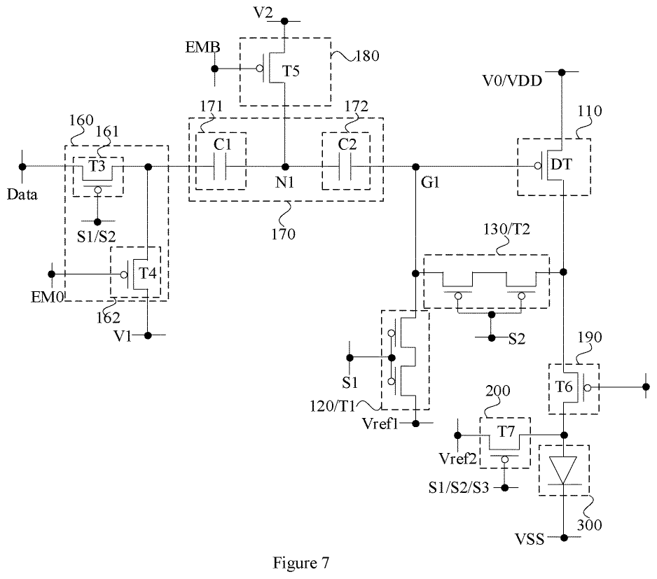

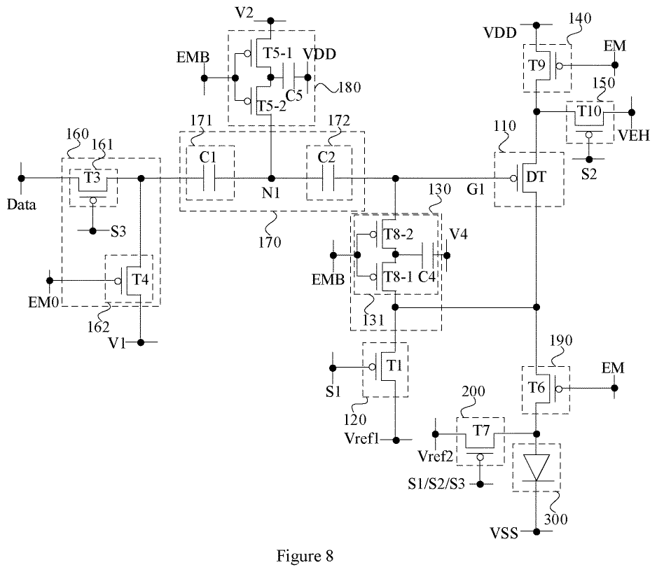

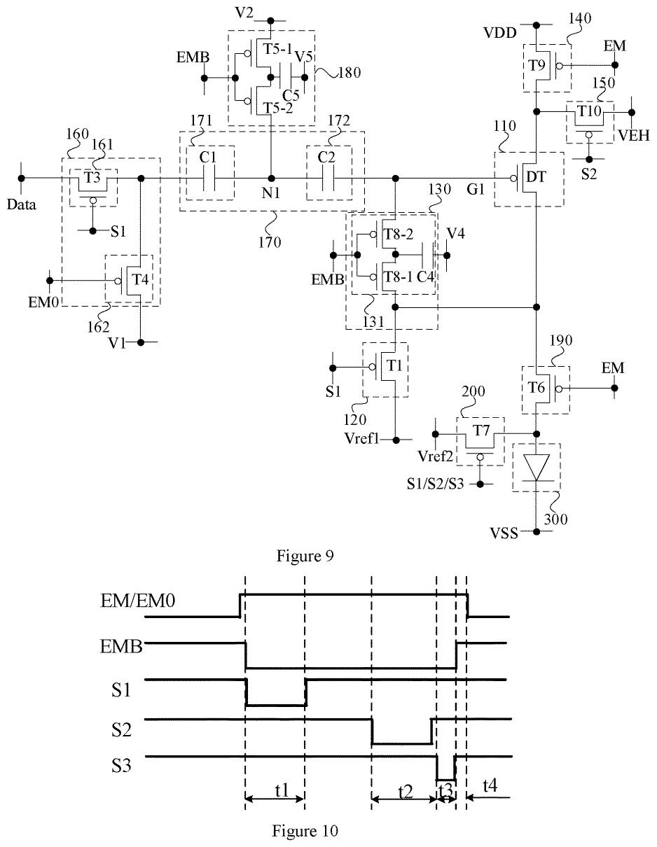

FIG. 6 is a schematic structural diagram of another pixel circuit provided by an embodiment of the present disclosure. FIG. 7 is a schematic structural diagram of yet another pixel circuit provided by an embodiment of the present disclosure. FIG. 8 is a schematic structural diagram of still another pixel circuit provided by an embodiment of the present disclosure. FIG. 9 is a schematic structural diagram of another pixel circuit provided by an embodiment of the present disclosure. FIG. 6 and FIG. 7 are based on the pixel circuit structure shown in FIG. 4, and FIG. 8 and FIG. 9 are based on the pixel circuit structure shown in FIG. 5.

Referring to FIG. 6 to FIG. 9, in an embodiment, the data writing module 160 includes a data writing unit 161 and a writing control unit 162. A first terminal of the data writing unit 161 is connected to a data line Data. A first terminal of the writing control unit 162 is connected to a first fixed voltage line. A control terminal of the writing control unit 162 is connected to a second light emission control signal line EMO. A second terminal of the data writing unit 161 and a second terminal of the writing control unit 162 are respectively connected to the first terminal of the storage coupling module 170. The data writing unit 161 is configured to transmit a data voltage to the first terminal of the storage coupling module 170 during a data writing phase. The writing control unit 162 is configured to, during a light emission phase, in response to a second light emission control signal on the second light emission control signal line EMO, transmit a first fixed voltage V1 to the first terminal of the storage coupling module 170.

In one embodiment, during the data writing phase, the data writing unit 161 is turned on, the writing control unit 162 is turned off, and the data writing unit 161 transmits the data voltage to the first terminal of the storage coupling module 170. During the light emission phase, the data writing unit 161 is turned off, the writing control unit 162 is turned on, and transmits the first fixed voltage V1 to the first terminal of the storage coupling module 170. The data writing unit 161 and the writing control unit 162 respectively include switching devices.

Referring to FIG. 6, the first initialization module 120 includes a first transistor T1, and the compensation module 130 includes a second transistor T2.

Referring to FIG. 6 to FIG. 9, the data writing unit 161 includes a third transistor T3, the writing control unit 162 includes a fourth transistor T4, and the node potential control module 180 includes a fifth transistor T5.

In an embodiment, both the fourth transistor T4 and the fifth transistor T5 include dual-gate transistors, reducing leakage currents of the fourth transistor T4 and the fifth transistor T5.

Continuing to refer to FIG. 6 to FIG. 9, in an embodiment, the pixel circuit further includes a second light emission control module 190. A control terminal of the second light emission control module 190 is connected to a first light emission control signal line EM. A first terminal of the second light emission control module 190 is connected to a second terminal of the driving module 110. A second terminal of the second light emission control module 190 is configured to be connected to the light emitting module 300. The second light emission control module 190 is configured to, during the light emission phase, be turned on in response to an active level of a first light emission control signal on the first light emission control signal line EM, and to be turned off in response to an inactive level of the first light emission control signal during periods other than the light emission phase. The periods other than the light emission phase include, but are not limited to, a first initialization phase, a data writing phase, and a compensation phase. By providing the second light emission control module 190, during periods other than the light emission phase, even if the driving module 110 is turned on to generate a driving current, this driving current is blocked by the second light emission control module 190 and cannot reach the light emitting module 300, thereby preventing erroneous light emission of the light emitting module 300 and improving display performance. Referring to FIG. 6 to FIG. 9, in an embodiment, the second light emission control module 190 includes a sixth transistor T6. In an embodiment, a frequency of the first light emission control signal is greater than or equal to a frequency of the second light emission control signal.

In the case of low-frequency display, a display frame includes a writing frame and a holding frame. In some embodiments, in the case of low-frequency display, the frequency of the first light emission control signal is greater than the frequency of the second light emission control signal. The first light emission control signal includes an active level in both the writing frame and the holding frame. The second light emission control signal includes an active level in the writing frame and does not include an active level in the holding frame. In other embodiments, in the case of low-frequency display, the frequency of the first light emission control signal is equal to the frequency of the second light emission control signal. The first light emission control signal includes an active level in both the writing frame and the holding frame. The second light emission control signal includes an active level in the writing frame and includes an active level in the holding frame.

In the case of high-frequency display, a display frame includes a writing frame, and the frequency of the first light emission control signal is equal to the frequency of the second light emission control signal.

Within the same frame, when both the first light emission control signal and the second light emission control signal include an active level, in an embodiment, a period of the active level of the first light emission control signal and a period of the active level of the second light emission control signal completely overlap.

In some embodiments, the pixel circuit further includes a third initialization module 200. The third initialization module 200 is configured to transmit a second initialization voltage to the second terminal of the second light emission control module 190 during a first initialization phase, a compensation phase, or a data writing phase.

In an embodiment, a control terminal of the third initialization module 200 is connected to a first scan signal line S1 or a second scan signal line S2. In one embodiment, it is possible to initialize the light emitting module 300 without the need to additionally provide a signal line in the display panel for controlling the third initialization module 200, simplifying the wiring structure in the display panel.

In an embodiment, the third initialization module 200 includes a seventh transistor T7.

In an embodiment, the first storage coupling unit 171 includes a first capacitor C1; the second storage coupling unit 172 includes a second capacitor C2; a first terminal of the first capacitor serves as a first terminal of the first storage coupling unit 171, and a second terminal of the first capacitor serves as a second terminal of the first storage coupling unit 171; a first terminal of the second capacitor C2 serves as a first terminal of the second storage coupling unit 172, and a second terminal of the second capacitor C2 serves as a second terminal of the second storage coupling unit 172.

Continuing to refer to FIG. 6 and FIG. 7, in an embodiment, a first terminal of the driving module 110 is connected to a first power line VDD, and a fixed voltage V0 is set equal to a first power voltage on the first power line VDD; a first terminal of the compensation module 130 is electrically connected to a second terminal of the driving module 110, a second terminal of the compensation module 130 is electrically connected to a control terminal G1 of the driving module 110, and the second terminal of the compensation module 130 is also electrically connected to a second terminal of the first initialization module 120.

Referring to FIG. 6 and FIG. 7, in an embodiment, a first transistor T1 of the first initialization module 120 is a dual-gate transistor, in an embodiment, referred to as a first dual-gate transistor. A second transistor T2 of the compensation module 130 may be a dual-gate transistor, in an embodiment, referred to as a second dual-gate transistor. In one embodiment, leakage currents of the first initialization module 120 and the compensation module 130 can be made smaller, thereby enabling the potential at the control terminal G1 of the driving module 110 to be maintained more effectively during a light-emitting phase, which is beneficial for improving display performance.

Referring to FIG. 6, in an embodiment, in the pixel circuit structure shown in FIG. 6 where the first terminal of the driving module 110 is connected to the first power line VDD and the fixed voltage V0 is set equal to the first power voltage on the first power line VDD, a control terminal of the data writing unit 161 is connected to a third scan signal line S3, and the data writing unit 161 is configured to, during a data writing phase, respond to an effective level of a third scan signal on the third scan signal line S3 to transmit a data voltage to a first terminal of the storage coupling module 170.

Referring to FIG. 6, in an embodiment, a first light emission control signal line EM is multiplexed as a second light emission control signal line EMO.

In some embodiments, a control terminal of the third initialization module 200 may also be connected to the third scan signal line S3.

FIG. 10 is a driving timing diagram of a pixel circuit provided by an embodiment of the present disclosure. This driving timing can be used to drive the pixel circuit shown in FIG. 6. Referring to FIG. 6 and FIG. 10, within one frame, the working process of the pixel circuit includes a first initialization phase t1, a compensation phase t2, a data writing phase t3, and a light-emitting phase t4. Herein, each transistor in the pixel circuit may be a P-type transistor or an N-type transistor. The following embodiments are described by taking an example where all transistors in the pixel circuit are P-type transistors.

In one embodiment, during the first initialization phase t1, a first scan signal is at a low level, the first transistor T1 is turned on, and transmits a first initialization voltage to a gate of the driving transistor. A first electrode of the driving transistor is connected to the first power voltage. In one embodiment, there is a large voltage bias between the first electrode and the gate of the driving transistor, thereby improving afterimage phenomena. Meanwhile, during the first initialization phase t1, a first control signal is at a low level, a fifth transistor T5 is turned on, and transmits a second fixed voltage V2 to a first internal node N1. During the first initialization phase t1, a first light emission control signal, a second light emission control signal, a second scan signal, and a third scan signal are all at a high level, and the corresponding controlled transistors are turned off. In a case where a seventh transistor T7 is connected to a first scan signal line S1, during the first initialization phase t1, the seventh transistor T7 is turned on and transmits a second initialization voltage to a first terminal of the light-emitting module 300, achieving initialization of the light-emitting module 300.

During the compensation phase t2, a second scan signal is at a low level, the second transistor T2 is turned on, and the first power voltage charges the gate of the driving transistor through the driving transistor and the second transistor T2 until a gate potential of the driving transistor equals a sum of the first power voltage and a threshold voltage of the driving transistor, Vdd+Vth, where Vdd represents the first power voltage and Vth represents the threshold voltage, and the driving transistor is turned off. During the compensation phase t2, the first control signal is at a low level, the fifth transistor T5 is turned on, and transmits the second fixed voltage V2 to the first internal node N1. In a case where the seventh transistor T7 is connected to a second scan signal line S2, during the compensation phase t2, the seventh transistor T7 is turned on and transmits the second initialization voltage to the first terminal of the light-emitting module 300, thereby achieving initialization of the light-emitting module 300. During the compensation phase t2, the first light emission control signal, the second light emission control signal, the first scan signal, and the third scan signal are at a high level, and the corresponding controlled transistors are turned off.

During the data writing phase t3, a third scan signal is at a low level, a third transistor T3 is turned on, and transmits a data voltage to a first terminal of the first capacitor. During the data writing phase t3, the first control signal is at a low level, the fifth transistor T5 is turned on, and transmits the second fixed voltage V2 to the first internal node N1. In a case where the seventh transistor T7 is connected to the third scan signal line S3, during the data writing phase t3, the seventh transistor T7 is turned on and transmits the second initialization voltage to the first terminal of the light-emitting module 300, thereby achieving initialization of the light-emitting module 300. During the data writing phase t3, the first light emission control signal, the second light emission control signal, the first scan signal, and the second scan signal are at a high level, and the corresponding controlled transistors are turned off.

During the light emission stage t4, the first light emission control signal and the second light emission control signal are at a low level, the fourth transistor T4 is turned on, transmitting the first fixed voltage V1 to the first terminal of the first capacitor, and the voltage at the first terminal of the first capacitor jumps from the data voltage to the first fixed voltage V1. During the light emission stage t4, the first control signal is at a high level, and the fifth transistor T5 is turned off. Therefore, due to the coupling effect of the first capacitor C1 and the second capacitor C2, a voltage containing the data voltage information is coupled to the gate of the driving transistor. In an embodiment, the first capacitor C1 and the second capacitor C2 together couple the voltage change at the first terminal of the first capacitor C1 (i.e., the difference between the first fixed voltage V1 and the data voltage) to the control terminal G1 of the driving module 110, so the voltage at the gate of the driving transistor is Vdd+Vth+V1−Vdata. Then, during the light emission stage t4, the sixth transistor T6 is turned on, and the driving current I generated by the driving transistor is

$$\begin{matrix}I = \frac{1}{2} μ {C}_{o x} \frac{W}{L} {( k * ( Vdd - ( Vdd + Vth + V 1 - Vdata ) + Vth ) )}^{2} \\ {= \frac{1}{2} μ {C}_{o x} \frac{W}{L} ( k * V 1 - Vdata ) )}^{2} ,\end{matrix}$$

where μ is the carrier mobility, Cox is the gate oxide capacitance (capacitance per unit area of the gate oxide), and W/L is the width-to-length ratio of the driving transistor DT. When the first terminal of the driving module 110 is connected to the first power line VDD, the first fixed voltage V1 is not equal to the first power supply voltage.

In one embodiment, the impact of the voltage drop of the first power line VDD during signal transmission on the display effect can be eliminated, improving display uniformity. During the light emission stage t4, the first control signal, the first scan signal, the second scan signal, and the third scan signal are all at a high level, and the corresponding controlled transistors are turned off. Continuing to refer to FIG. 10, in an embodiment, within one frame, the effective level of the third scan signal occurs after the effective level of the second scan signal. In one embodiment, the data writing stage t3 of the pixel circuit is separated from the compensation stage t2, meaning that the data writing stage t3 and the compensation stage t2 do not occur simultaneously, which can reduce mutual constraints and influences between them. In some embodiments, the pulse width duration of the effective level of the third scan signal is shorter than that of the effective level of the second scan signal. This configuration allows the data writing stage t3 to be relatively short, enabling high refresh rates.

On the other hand, it allows the compensation stage t2 to be relatively long, thereby making the threshold voltage compensation for the driving module 110 more sufficient, improving display uniformity, and enhancing image display quality. Referring to FIG. 7, when the first terminal of the driving module 110 is connected to the first power line VDD and the fixed voltage V0 is set equal to the first power supply voltage on the first power line VDD, in some embodiments, the control terminal of the data writing unit 161 is connected to the first scan signal line S1. During the data writing stage t3, in response to the effective level of the first scan signal on the first scan signal line S1, the data voltage is transmitted to the first terminal of the storage coupling module 170. The data writing stage t3 and the first initialization stage t1 occur simultaneously. In one embodiment, the control terminal of the data writing unit 161 is connected to the second scan signal line S2.

During the data writing stage t3, in response to the effective level of the second scan signal on the second scan signal line S2, the data voltage is transmitted to the first terminal of the storage coupling module 170. The data writing stage t3 and the compensation stage t2 occur simultaneously. This configuration utilizes the first scan signal line S1, which controls the first initialization module 120, or the second scan signal line S2, which controls the compensation module 130, to control the data writing unit 161. This eliminates the need for an additional signal line to control the data writing unit 161, reducing the number of signal lines in the display panel and simplifying the wiring structure. Referring to FIG. 7,

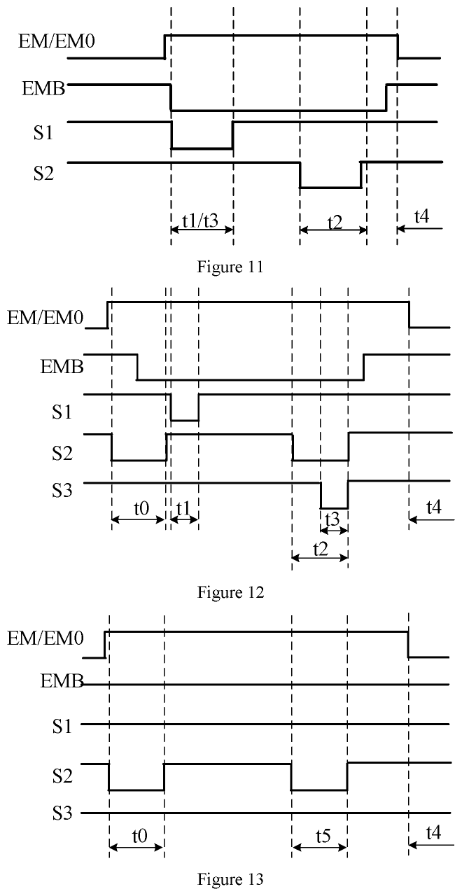

in an embodiment, the first light emission control signal line EM is multiplexed as the second light emission control signal line EMO. FIG. 11 is another driving timing diagram of a pixel circuit provided by an embodiment of the present disclosure. This driving timing can be used to drive the pixel circuit shown in FIG. 7. The driving timing shown in FIG. 11 corresponds to the circuit structure where the control terminal of the data writing unit 161 is connected to the first scan signal line S1. Referring to FIGS. 7 and 11, within one frame, the working process of the pixel circuit includes a first initialization stage t1, a compensation stage t2, a data writing stage t3, and a light emission stage t4. When the control terminal of the data writing unit 161 is connected to the first scan signal line S1, the data writing stage t3 and the first initialization stage t1 occur simultaneously.

During the first initialization stage t1 (data writing stage t3), the first scan signal is at a low level, and the third transistor T3 is turned on, transmitting the data voltage to the first terminal of the first capacitor. The working conditions of the other transistors are the same as those of the pixel circuit in FIG. 6 during the first initialization stage t1. During the compensation stage t2 and the light emission stage t4, the working conditions of each transistor are the same as those of the pixel circuit in FIG. 6 during the compensation stage t2 and the light emission stage t4, respectively, and will not be repeated here. When the control terminal of the data writing unit 161 is connected to the second scan signal line S2, the data writing stage t3 and the compensation stage t2 occur simultaneously. During the first initialization stage t1, the working conditions of each transistor are the same as those of the pixel circuit in FIG. 6 during the first initialization stage t1, and will not be repeated here.

During the compensation stage t2 (data writing stage t3), the second scan signal is at a low level, and the third transistor T3 is turned on, transmitting the data voltage to the first terminal of the first capacitor. The working conditions of the other transistors are the same as those of the pixel circuit in FIG. 6 during the compensation stage t2. During the light emission stage t4, the working conditions of each transistor are the same as those of the pixel circuit in FIG. 6 during the light emission stage t4, and will not be repeated here.

Referring to FIGS. 10-11, within one frame, the effective level of the second scan signal occurs after the effective level of the first scan signal. In one embodiment, it can be ensured that the compensation phase t2 is performed after the first initialization phase t1, and after the control terminal G1 of the driving module 110 is written with the first initialization voltage during the first initialization phase t1, the driving module 110 can be turned on during the compensation phase t2 based on the first power supply voltage at its own first terminal and the first initialization voltage at its control terminal, charging the control terminal G1 of the driving module 110 through the driving module 110 and the compensation module 130, until the voltage at the control terminal G1 of the driving module 110 equals the sum of the first power supply voltage and the threshold voltage of the driving module 110.

Moreover, since the compensation phase t2 is performed after the first initialization phase t1, during the first initialization phase t1 and the period between the first initialization phase t1 and the compensation phase t2, a large voltage difference is maintained between the first terminal and the control terminal of the driving module 110, thereby extending the duration for which the voltage bias between the first terminal and the control terminal of the driving module 110 is maintained, which is beneficial for further improving image sticking.

In some embodiments, the effective level of the second scan signal is the same as the effective level of the first scan signal, and the pulse width duration of the effective level of the second scan signal is the same as the pulse width duration of the effective level of the first scan signal. In one embodiment, the first scan signal and the second scan signal can be provided by different stages of shift registers of the same scan driving circuit, thereby reducing the number of scan driving circuits in the display panel, which is beneficial for achieving a narrow bezel.

Referring to FIG. 8, in an embodiment, when the pixel circuit further includes a first light emission control module 140 and a second initialization module 150, the control terminal of the first light emission control module 140 is connected to a first light emission control signal line EM, the first terminal of the first light emission control module 140 is connected to a first power line VDD, and the second terminal of the first light emission control module 140 is connected to the first terminal of the driving module 110; the control terminal of the second initialization module 150 is connected to a second scan signal line S2, the first terminal of the second initialization module 150 is connected to a second power line VEH, and the second terminal of the second initialization module 150 is connected to the first terminal of the driving module 110, the compensation module 130 includes a first compensation unit 131, the control terminal of the first compensation unit 131 is connected to a first control signal line EMB, and the first compensation unit 131 is connected between the control terminal G1 of the driving module 110 and the second terminal of the driving module 110; the first compensation unit 131 is configured to, during the first initialization phase t1, turn on in response to the effective level of the first control signal, transmitting the first initialization voltage to the control terminal G1 of the driving module 110; and during the compensation phase t2, turn on in response to the effective level of the first control signal, transmitting voltage information related to the threshold voltage of the driving module 110 to the control terminal G1 of the driving module 110; and during the data writing phase t3, turn on in response to the effective level of the first control signal; the first initialization module 120 is connected to the control terminal G1 of the driving module 110 through the first compensation unit 131.

In one embodiment, the control terminal of the first compensation unit 131 is connected to the first control signal line EMB, meaning that the control terminal of the first compensation unit 131 is connected to the same signal line as the control terminal of the node potential control module 180, which can reduce the number of signal lines in the display panel. During the first initialization phase t1, the first compensation unit 131 turns on in response to the effective level of the first control signal, while the first initialization module 120 turns on in response to the effective level of the first scan signal, enabling the first initialization voltage to be transmitted to the control terminal G1 of the driving module 110 through the first initialization module 120 and the first compensation unit 131, thereby initializing the control terminal G1 of the driving module 110.

During the compensation phase t2, the first compensation unit 131 turns on in response to the effective level of the first scan signal, transmitting voltage information related to the threshold voltage of the driving module 110 to the control terminal G1 of the driving module 110, thereby achieving threshold voltage compensation for the driving module 110.

In an embodiment, the first compensation unit 131 includes an eighth transistor T8, the second light emission control module 190 includes a ninth transistor T9, and the second initialization module 150 includes a tenth transistor T10.

In an embodiment, the second power supply voltage is greater than or equal to the first power supply voltage on the first power line VDD. It ensures that during the first initialization phase t1, the voltage difference between the first terminal and the control terminal of the driving module 110 is large, providing a greater voltage bias between the first terminal and the control terminal of the driving module 110, thereby further improving image sticking.

In some embodiments, the first power line VDD is multiplexed as the second power line VEH. Such an arrangement can reduce the number of signal lines in the display panel and simplify the wiring structure.

In an embodiment, one display frame at least includes a writing frame, and the writing frame includes a first initialization phase t1, a compensation phase t2, a data writing phase t3, and a light emission phase t4. In some embodiments, the display frame further includes a holding frame.

Continuing to refer to FIG. 8, in some embodiments, the control terminal of the data writing unit 161 is connected to a third scan signal line S3, and the data writing unit 161 is configured to, during the data writing phase t3, turn on in response to the effective level of the third scan signal on the third scan signal line S3, transmitting the data voltage to the first terminal of the storage coupling module 170; the third scan signal maintains an ineffective level during the holding frame.

FIG. 12 is a driving timing diagram of a pixel circuit in a writing frame according to an embodiment of the present disclosure. This driving timing can be used for driving the pixel circuit shown in FIG. 8 during the writing frame. Referring to FIG. 8 and FIG. 12, the writing frame includes a first initialization phase t1, a compensation phase t2, a data writing phase t3, and a light emission phase t4.

Referring to FIG. 8 and FIG. 12, in the first initialization phase t1, the first scan signal is at a low level, the first transistor T1 is turned on, the first control signal is at a low level, the eighth transistor T8 is turned on, and the first transistor T1 and the eighth transistor T8 transmit the first initialization voltage to the gate of the driving transistor. A fixed voltage V0 (in an embodiment, the first power supply voltage and the second power supply voltage) can be transmitted to the first electrode of the driving transistor before the first initialization phase t1. In one embodiment, there is a large voltage bias between the first electrode and the gate of the driving transistor, thereby improving the afterimage phenomenon. Meanwhile, in the first initialization phase t1, the first control signal is at a low level, the fifth transistor T5 is turned on, and transmits the second fixed voltage V2 to the first internal node N1. In the first initialization phase t1, the first light emission control signal, the second light emission control signal, the second scan signal, and the third scan signal are all at a high level, and the corresponding controlled transistors are turned off. In the case where the seventh transistor T7 is connected to the first scan signal line S1, in the first initialization phase t1, the seventh transistor T7 is turned on and transmits the second initialization voltage to the first terminal of the light emitting module 300, thereby initializing the light emitting module 300.

In the compensation phase t2, the second scan signal is at a low level, the second transistor T2 and the tenth transistor T10 are turned on, and the second power supply voltage charges the gate of the driving transistor through the driving transistor and the second transistor T2 until the gate potential of the driving transistor equals the sum of the second power supply voltage and the threshold voltage of the driving transistor, Veh+Vth, where Veh represents the second power supply voltage, Vth represents the threshold voltage, and the driving transistor is turned off. In the compensation phase t2, the first control signal is at a low level, the fifth transistor T5 is turned on, and transmits the second fixed voltage V2 to the first internal node N1. In the case where the seventh transistor T7 is connected to the second scan signal line S2, in the compensation phase t2, the seventh transistor T7 is turned on and transmits the second initialization voltage to the first terminal of the light emitting module 300, thereby initializing the light emitting module 300. In the compensation phase t2, the first light emission control signal, the second light emission control signal, and the first scan signal are at a high level, and the corresponding controlled transistors are turned off.

In the data writing phase t3, the third scan signal is at a low level, the third transistor T3 is turned on, and transmits the data voltage to the first terminal of the first capacitor. In the data writing phase t3, the first control signal is at a low level, the fifth transistor T5 is turned on, and transmits the second fixed voltage V2 to the first internal node N1. In the case where the seventh transistor T7 is connected to the third scan signal line S3, in the data writing phase t3, the seventh transistor T7 is turned on and transmits the second initialization voltage to the first terminal of the light emitting module 300, thereby initializing the light emitting module 300. In the data writing phase t3, the first light emission control signal, the second light emission control signal, and the first scan signal are at a high level, and the corresponding controlled transistors are turned off.

Referring to FIG. 12, in an embodiment, the effective level of the third scan signal overlaps with the effective level of the second scan signal corresponding to the compensation phase t2. In some embodiments, the pulse width duration of the effective level of the third scan signal is less than the pulse width duration of the effective level of the second scan signal. With such a setting, on one hand, the time of the data writing phase t3 can be made shorter, enabling a high refresh rate. On the other hand, the time of the compensation phase t2 can be made longer, thereby making the threshold voltage compensation for the driving module 110 more sufficient, further improving display uniformity and enhancing picture display quality. Moreover, by setting the effective level of the third scan signal to overlap with the effective level of the second scan signal corresponding to the compensation phase t2, the data writing phase t3 can be performed during part of the period of the compensation phase t2, which is beneficial for further increasing the refresh rate of the display panel. In an embodiment, the start time of the data writing phase t3 is after the start time of the compensation phase t2, and the end time of the data writing phase t3 is the same as the end time of the compensation phase t2.

In the light emission phase t4, the first light emission control signal and the second light emission control signal are at a low level, the fourth transistor T4 is turned on, and transmits the first fixed voltage V1 to the first terminal of the first capacitor. The voltage at the first terminal of the first capacitor jumps from the data voltage to the first fixed voltage V1. In the light emission phase t4, the first control signal is at a high level signal, and the fifth transistor T5 is turned off. Therefore, due to the coupling effect of the first capacitor C1 and the second capacitor C2, a voltage containing data voltage information is coupled to the gate of the driving transistor.

In an embodiment, the first capacitor C1 and the second capacitor C2 together couple the voltage change amount at the first terminal of the first capacitor C1 (that is, the difference between the first fixed voltage V1 and the data voltage) to the control terminal G1 of the driving module 110. Then, the voltage at the gate of the driving transistor is Veh+Vth+V1−Vdata. In the light emission phase t4, the sixth transistor T6 and the ninth transistor T9 are turned on. Then, the driving current I generated by the driving transistor is

$$\begin{matrix}I = \frac{1}{2} μ {C}_{o x} \frac{W}{L} {( k * ( Vdd - ( Veh + Vth + V 1 - Vdata ) + Vth ) )}^{2} \\ = \frac{1}{2} μ {C}_{o x} \frac{W}{L} {( k * ( V 1 + Veh - Vdd - Vdata ) )}^{2} ,\end{matrix}$$

where μ is the carrier mobility, Cox is the gate oxide layer capacitance (capacitance per unit area of the gate oxide), and W/L is the width-to-length ratio of the driving transistor DT. In the pixel circuit structure shown in FIG. 8, the pixel circuit further includes a first light emission control module 140 and a second initialization module 150. The control terminal of the first light emission control module 140 is connected to the first light emission control signal line EM, the first terminal of the first light emission control module 140 is connected to the first power line VDD, and the second terminal of the first light emission control module 140 is connected to the first terminal of the driving module 110. The control terminal of the second initialization module 150 is connected to the second scan signal line S2, the first terminal of the second initialization module 150 is connected to the second power line VEH, and the second terminal of the second initialization module 150 is connected to the first terminal of the driving module 110. In this case, the first fixed voltage V1 is equal to the first power supply voltage.

Then, the driving current I equals

$$I = \frac{1}{2} μ {C}_{o x} \frac{W}{L} {( k * ( Veh - Vdata ) )}^{2} .$$

In this way, the impact of the voltage drop of the first power line VDD during signal transmission on the display effect can be eliminated, and display uniformity can be improved. In the light emission phase t4, the first control signal, the first scan signal, the second scan signal, and the third scan signal are all at a high level signal, and the corresponding controlled transistors are turned off.

Continuing to refer to FIG. 12, in an embodiment, the effective level of the third scan signal is the same as the effective level of the first scan signal, and the pulse width duration of the effective level of the third scan signal is the same as the pulse width duration of the effective level of the first scan signal. In one embodiment, the first scan signal and the third scan signal can be provided by different stages of shift registers of the same scan driving circuit, thereby reducing the number of scan driving circuits in the display panel, which is beneficial for achieving a narrow bezel.

In the case of a low refresh rate, the display frame further includes a hold frame. The first light emission control signal and the second scan signal are high-frequency signals, and the first control signal, the first scan signal, and the third scan signal are low-frequency signals. FIG. 13 is a driving timing diagram of a pixel circuit in a hold frame according to an embodiment of the present disclosure. This driving timing can be used for driving the pixel circuit shown in FIG. 8 during the hold frame. Referring to FIG. 8 and FIG. 13, the hold frame includes a first characteristic improvement stage t5 and a light emission stage t4. The second initialization module 150 is further configured to transmit the second power supply voltage to the first terminal of the driving module 110 during the first characteristic improvement stage t5.

In an embodiment, during the hold frame, the first control signal remains at an invalid level. In an embodiment, during the hold frame, the first scan signal and the third scan signal remain at invalid levels.

During the first characteristic improvement stage t5, the second scan signal is at a low level, the first light emission control signal is at a high level, and the first control signal, the first scan signal, and the third scan signal are all at high levels. The tenth transistor T10 is turned on, transmitting the second power supply voltage to the first electrode of the driving transistor. Thus, during the first characteristic improvement stage t5, the driving transistor will be turned on, generating a driving current from the first electrode to the second electrode of the driving transistor, causing current stress in the driving transistor during the first characteristic improvement stage t5, further improving image sticking.

During the light emission stage t4, the operation process of the pixel circuit is the same as that of the pixel circuit during the light emission stage t4 of the write frame, and will not be repeated here.

In the driving timing shown in FIG. 13, the frequency of the second light emission control signal is the same as that of the first light emission control signal.

In an embodiment, the frequency of the second light emission control signal is equal to the frequency of the third scan signal.

In an embodiment, the write control unit 162 is configured to, during the light emission stage of the write frame, respond to the second light emission control signal on the second light emission control signal line and transmit the first fixed voltage to the first terminal of the storage coupling module.

In some embodiments, during the hold frame, the second light emission control signal remains at an invalid level. Since during the hold frame, there is no need to couple voltage information related to the data voltage to the control terminal of the driving module, during the hold frame, the second light emission control signal remains at an invalid level, and the write control unit 162 is in an off state during the hold frame, thereby saving power consumption of the display panel.

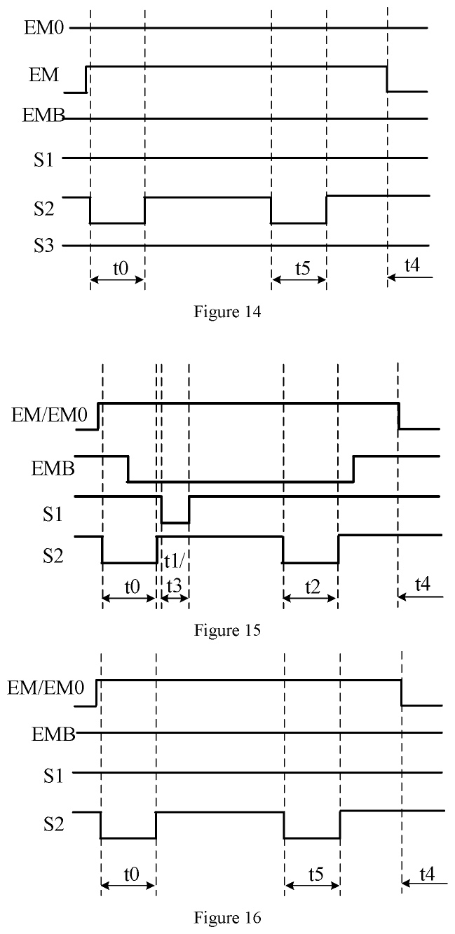

FIG. 14 is another driving timing diagram of a pixel circuit in a hold frame according to an embodiment of the present disclosure. This driving timing can be used for driving the pixel circuit shown in FIG. 8 during the hold frame. Referring to FIG. 8 and FIG. 14, the difference from FIG. 13 is that the second light emission control signal remains at an invalid level during the hold frame.

Continuing to refer to FIG. 8, FIG. 12 to FIG. 14, in an embodiment, before the first initialization stage t1 of the write frame and before the first characteristic improvement stage t5 of the hold frame, a second characteristic improvement stage t0 is further included. The second initialization module 150 is further configured to, during the second characteristic improvement stage t0, respond to the effective level of the second scan signal on the second scan signal line S2 and transmit the second power supply voltage on the second power supply line VEH to the first terminal of the driving module 110. The compensation module 130 is further configured to, during the second characteristic improvement stage to of the write frame, charge the control terminal G1 of the driving module 110 according to the second power supply voltage.

During the second characteristic improvement stage to of the write frame, the second scan signal is at a low level, the first control signal is at a low level, the fifth transistor T5, the eighth transistor T8, and the tenth transistor T10 are turned on, the first scan signal, the third scan signal, the first light emission control signal, and the second light emission control signal are at high levels, and other transistors are turned off. The tenth transistor T10 transmits the second power supply voltage to the first electrode of the driving transistor. The driving transistor and the eighth transistor T8 are turned on, and the second power supply voltage charges the gate of the driving transistor. During this stage, the driving transistor generates a driving current, causing current stress in the driving transistor, further improving image sticking.

During the second characteristic improvement stage t of the hold frame, the driving transistor will be turned on, generating a driving current from the first electrode to the second electrode of the driving transistor, causing current stress in the driving transistor during the second characteristic improvement stage to of the hold frame, further improving image sticking.

Continuing to refer to FIG. 9, in other embodiments, the control terminal of the data writing unit 161 is connected to the first scan signal line S1. The data writing module 160 is configured to, during the data writing stage t3, respond to the effective level of the first scan signal to turn on and transmit the data voltage to the first terminal of the storage coupling module 170. During the hold frame, the first scan signal remains at an invalid level. FIG. 15 is another driving timing diagram of a pixel circuit in a write frame according to an embodiment of the present disclosure. This driving timing can be used for driving the pixel circuit shown in FIG. 9 during the write frame.

Referring to FIG. 9 and FIG. 15, the write frame includes a first initialization stage t1, a compensation stage t2, a data writing stage t3, and a light emission stage t4. Since the control terminal of the data writing unit 161 and the control terminal of the first initialization module 120 are connected to the same signal line, i.e., the first scan signal line S1, the data writing stage t3 and the first initialization stage t1 are performed simultaneously. In one embodiment, the number of signal lines in the display panel can be reduced, simplifying the wiring structure.

Referring to FIG. 9 and FIG. 15, during the first initialization phase t1, the first scan signal is at a low level, the third transistor T3 is turned on, and the data voltage is transmitted to the first terminal of the first capacitor. The operating conditions of the other transistors are the same as those of the pixel circuit in FIG. 8 during the first initialization phase t1. During the compensation phase t2 and the light emission phase t4, the operating conditions of the transistors are the same as those of the pixel circuit in FIG. 8 during the compensation phase t2 and the light emission phase t4, respectively, and will not be repeated here. Referring to FIG. 14, in an embodiment, the pulse width duration of the effective level of the second scan signal is greater than the pulse width duration of the effective level of the first scan signal. FIG. 16 is a driving timing diagram of another pixel circuit in a hold frame provided by an embodiment of the present disclosure. This driving timing can be used to drive the pixel circuit shown in FIG. 9 in the hold frame.

Referring to FIG. 9 and FIG. 16, the hold frame includes a first characteristic improvement phase t5 and a light emission phase t4. The second initialization module 150 is further configured to transmit the second power supply voltage to the first terminal of the driving module 110 during the first characteristic improvement phase t5. In an embodiment, in the hold frame, the first control signal remains at an invalid level.

In an embodiment, in the hold frame, the first scan signal remains at an invalid level. During the first characteristic improvement phase t5, the second scan signal is at a low level, the first light emission control signal and the second light emission control signal are at a high level, the first control signal and the first scan signal are both at a high level, and the tenth transistor T10 is turned on, transmitting the second power supply voltage to the first electrode of the driving transistor. During the first characteristic improvement phase t5, the driving transistor will be turned on, generating a driving current from the first electrode to the second electrode of the driving transistor, causing current stress in the driving transistor during the first characteristic improvement phase t5, further improving image sticking.

During the light emission phase t4, the operation process of the pixel circuit is the same as that of the pixel circuit in the light emission phase t4 of the write frame, and will not be repeated here. In the driving timing shown in FIG. 16, the frequency of the second light emission control signal is the same as that of the first light emission control signal. In an embodiment, the frequency of the second light emission control signal is equal to the frequency of the first scan signal. In an embodiment, the write control unit 162 is configured to, during the light emission phase of the write frame, in response to the second light emission control signal on the second light emission control signal line, transmit the first fixed voltage to the first terminal of the storage coupling module.

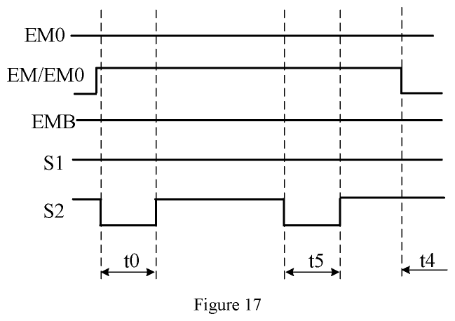

In some embodiments, in the hold frame, the second light emission control signal remains at an invalid level. Since in the hold frame, there is no need to couple voltage information related to the data voltage to the control terminal of the driving module, in the hold frame, the second light emission control signal remains at an invalid level, the write control unit 162 is in an off state during the hold frame, thereby saving power consumption of the display panel. FIG. 17 is a driving timing diagram of another pixel circuit in a hold frame provided by an embodiment of the present disclosure. This driving timing can be used to drive the pixel circuit shown in FIG. 9 in the hold frame. Referring to FIG. 9 and FIG. 17, the difference from FIG. 16 is that the second light emission control signal remains at an invalid level in the hold frame.

Continuing to refer to FIG. 9 and FIG. 15 to FIG. 17, in an embodiment, before the first initialization phase t1 of the write frame and before the first characteristic improvement phase t5 of the hold frame, a second characteristic improvement phase t0 is further included. The second initialization module 150 is further configured to, during the second characteristic improvement phase t0, in response to the effective level of the second scan signal on the second scan signal line S2, transmit the second power supply voltage on the second power supply line VEH to the first terminal of the driving module 110. The compensation module 130 is further configured to, during the second characteristic improvement phase to of the write frame, charge the control terminal G1 of the driving module 110 according to the second power supply voltage. During the second characteristic improvement phase t0 of the write frame, the second scan signal is at a low level, the first control signal is at a low level, the fifth transistor T5, the eighth transistor T8, and the tenth transistor T10 are turned on, the first scan signal, the first light emission control signal, and the second light emission control signal are at a high level, and the other transistors are turned off. The tenth transistor T10 transmits the second power supply voltage to the first electrode of the driving transistor, and the driving transistor and the eighth transistor T8 are turned on, charging the gate of the driving transistor from the second power supply voltage line. In this phase, the driving transistor generates a driving current, causing current stress in the driving transistor, further improving image sticking.

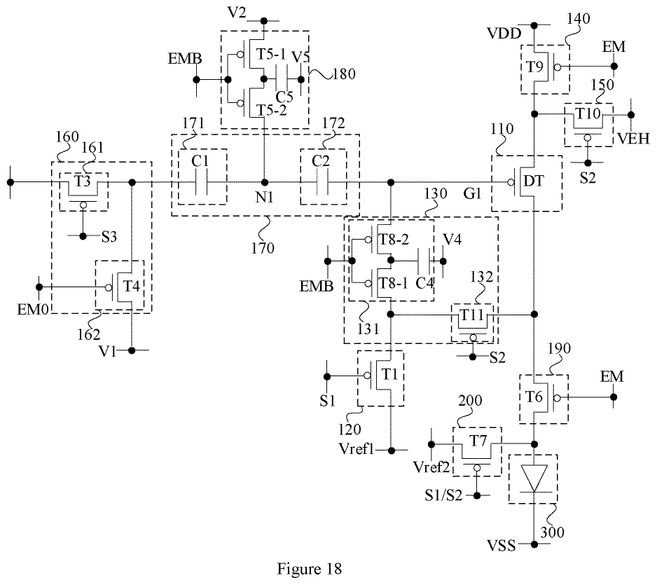

During the second characteristic improvement phase to of the hold frame, the driving transistor will be turned on, generating a driving current from the first electrode to the second electrode of the driving transistor, causing current stress in the driving transistor during the second characteristic improvement phase to of the hold frame, further improving image sticking. FIG. 18 is a schematic structural diagram of another pixel circuit provided by an embodiment of the present disclosure. The driving timings shown in FIG. 12 to FIG. 14 are also applicable to driving the pixel circuit shown in FIG. 18.

Referring to FIG. 12 to FIG. 14 and FIG. 18, in an embodiment, the compensation module 130 further includes a second compensation unit 132. The control terminal of the second compensation unit 132 is connected to the second scan signal line S2, the first terminal of the second compensation unit 132 is connected to the second terminal of the driving module 110, the second terminal of the second compensation unit 132 is connected to the first terminal of the first compensation unit 131, and the second terminal of the first compensation unit 131 is connected to the control terminal G1 of the driving module 110. The second compensation unit 132 is configured to, during the compensation phase t2, in response to the effective level of the second scan signal, turn on and transmit voltage information related to the threshold voltage of the driving module 110 to the control terminal G1 of the driving module 110 through the first compensation unit 131. In an embodiment, the second compensation unit 132 includes an eleventh transistor T11.

In one embodiment, since the first control signal remains at a low level during the first initialization phase t1, the compensation phase t2, and the data writing phase t3, the eighth transistor T8 is in an on state during the first initialization phase t1, the compensation phase t2, and the data writing phase t3. In this embodiment, by providing the second compensation unit 132 between the first compensation unit 131 and the second terminal of the driving module 110, the conduction state between the control terminal G1 and the second terminal of the driving module 110 can be further controlled through the second compensation unit 132.

With reference to FIGS. 12-14 and FIG. 18, illustratively, the second compensation unit 132 is further configured to, in the second characteristic improvement phase t0, conduct in response to the effective level of the second scan signal, to charge the control terminal G1 of the driving module 110 through the first compensation unit 131 during the second characteristic improvement phase to of the writing frame. In one embodiment, during the second characteristic improvement phase t0 of the writing frame, the driving module 110 generates a driving current, and charges the control terminal G1 of the driving module 110 through the driving module 110, the second compensation unit 132, and the first compensation unit 131, causing the driving module 110 to experience current stress, thereby improving image sticking. In an embodiment, the second compensation unit 132 is further configured to, in the first initialization phase t1, turn off in response to the ineffective level of the second scan signal, thereby ensuring that during the first initialization phase t1, the gate and the second electrode of the driving transistor are not connected, and thus a large voltage difference can be maintained between the gate and the first electrode of the driving transistor, which is beneficial for enhancing the improvement effect on image sticking. In some embodiments, when the data writing phase t3 and the compensation phase t2 are not performed simultaneously, the second compensation unit 132 is further configured to, in the data writing phase t3, turn off in response to the ineffective level of the second scan signal. FIG. 18 is based on the pixel circuit shown in FIG. 8, with the compensation module 130 further including the second compensation unit 132.

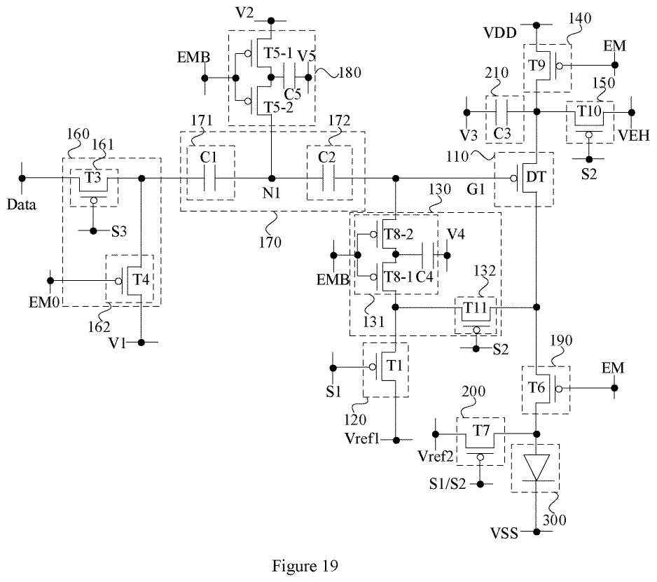

Similarly, based on the pixel circuit shown in FIG. 9, the compensation module 130 can also further include the second compensation unit 132, which will not be repeated here. FIG. 19 is a schematic structural diagram of another pixel circuit provided by an embodiment of the present disclosure.

Referring to FIG. 19, in an embodiment, the pixel circuit further includes a storage and hold module 210. The storage and hold module 210 is connected to the first terminal of the driving module 110 and is used to store and hold the voltage at the first terminal of the driving module 110. By providing the storage and hold module 210, during periods when the second scan signal is at an ineffective level and the second compensation unit 132 is turned off (in an embodiment, during the first initialization phase t1, and the period between the first initialization phase t1 and the compensation phase t2), the voltage at the first terminal of the driving module 110 can be well maintained. Consequently, during the first initialization phase t1 and the period between the first initialization phase t1 and the compensation phase t2, a large voltage bias is maintained between the first terminal and the control terminal of the driving module 110, thereby more effectively improving image sticking.

In an embodiment, during periods when the first control signal is at an ineffective level and the first compensation unit 131 is turned off (in an embodiment, during the first characteristic improvement phase t5 and the second characteristic improvement phase t0), the voltage at the first terminal of the driving module 110 can be well maintained. As a result, during the first characteristic improvement phase t5 and the second characteristic improvement phase t0, the driving current generated by the driving module 110 is larger, ensuring stronger current stress in the driving module 110 and improving image sticking.

Referring to FIG. 17, in an embodiment, the storage and hold module 210 includes a third capacitor C3. The first terminal of the third capacitor C3 is connected to a third fixed voltage V3, and the second terminal of the third capacitor C3 is connected to the first terminal of the driving module 110. In an embodiment, the third fixed voltage V3 is equal to one of the first fixed voltage V1, the first power supply voltage, the second power supply voltage, the second fixed voltage V2, and the first initialization voltage. In one embodiment, there is no need to additionally provide a signal line for transmitting the third fixed voltage, further reducing the number of wirings in the display panel and simplifying the wiring layout.

With reference to FIGS. 10-17, in an embodiment, within one frame, the effective level of the first control signal is within the period of the ineffective level of the second light emission control signal; the node potential control module is configured to conduct in response to the effective level of the first control signal. In some embodiments, within one frame, the start time of the effective level of the first control signal is after the start time of the ineffective level of the second light emission control signal, and the end time of the effective level of the first control signal is before the end time of the ineffective level of the second light emission control signal. With this arrangement, after the fourth transistor is turned off in the previous frame, the fifth transistor is turned on in the next frame, with a time interval between them; moreover, within one frame, after the fifth transistor is turned off, the fourth transistor is turned on, with a time interval between them as well, preventing the fourth transistor and the fifth transistor from conducting simultaneously, which would prevent the data voltage from being coupled to the control terminal of the driving module, thereby ensuring that the pixel circuit can operate normally.

Continuing to refer to FIGS. 8, 9, 18, and 19, in an embodiment, the eighth transistor T8 included in the first compensation unit 131 is a dual-gate transistor. In an embodiment, the dual-gate transistor of the eighth transistor T8 is referred to as a third dual-gate transistor. The third dual-gate transistor includes a first sub-transistor T8-1 and a second sub-transistor T8-2. The gate of the first sub-transistor T8-1 and the gate of the second sub-transistor T8-2 are connected to the first control signal line EMB. The first electrode of the first sub-transistor T8-1 is connected to the first initialization module 120. The second electrode of the first sub-transistor T8-1 is connected to the first electrode of the second sub-transistor T8-2. The second electrode of the second sub-transistor T8-2 is connected to the control terminal G1 of the driving module 110. By configuring the first compensation unit 131 to include the third dual-gate transistor, the leakage current of the first compensation unit 131 is reduced, ensuring that the gate potential of the driving transistor can be better maintained, improving display performance, enabling the pixel circuit to maintain good display performance even at low refresh rates, and thereby achieving wide-frequency driving.

In one embodiment, in the third dual-gate transistor, the second sub-transistor T8-2 is directly connected to the control terminal G1 of the driving module 110. In an embodiment, the channel area of the second sub-transistor T8-2 is smaller than the channel area of the first sub-transistor T8-1. With such a configuration, the leakage current of the second sub-transistor T8-2 directly connected to the control terminal G1 of the driving module 110 can be made smaller, allowing the potential of the control terminal G1 of the driving module 110 to be maintained more effectively, further ensuring the display effect and achieving wide-frequency driving. In some embodiments, the channel area of the second sub-transistor T8-2 is smaller than the channel area of other transistors in the same pixel circuit. That is, the channel area of the second sub-transistor T8-2 is smaller than the channel area of any transistor in the same pixel circuit except for the second sub-transistor T8-2.

Continuing to refer to FIG. 8, FIG. 9, FIG. 18, and FIG. 19, in an embodiment, the first compensation unit 131 further includes a fourth capacitor C4. The first terminal of the fourth capacitor C4 is connected to a fourth fixed voltage V4, and the second terminal of the fourth capacitor C4 is connected to the second electrode of the first sub-transistor T8-1. With such a configuration, when the high and low levels of the first control signal transition, the potential of the intermediate node between the first sub-transistor T8-1 and the second sub-transistor T8-2 will not be affected. This ensures that when the eighth transistor T8 is turned off, the intermediate node between the first sub-transistor T8-1 and the second sub-transistor T8-2 can be well maintained, further ensuring that the leakage current of the eighth transistor T8 is small and guaranteeing the display effect during low-frequency display.

In an embodiment, the fourth fixed voltage V4 is equal to one of the first fixed voltage V1, the first power supply voltage, the second power supply voltage, the second fixed voltage V2, and the first initialization voltage, thereby reducing the number of wirings in the display panel.

Continuing to refer to FIG. 8, FIG. 9, FIG. 18, and FIG. 19, in an embodiment, the node potential control module 180 includes a fourth dual-gate transistor. The fourth dual-gate transistor includes a third sub-transistor T5-1 and a fourth sub-transistor T5-2. The gate of the third sub-transistor T5-1 and the gate of the fourth sub-transistor T5-2 are connected to the first control signal line EMB. The first electrode of the third sub-transistor T5-1 is connected to the second fixed voltage V2 line. The second electrode of the third sub-transistor T5-1 is connected to the first electrode of the fourth sub-transistor T5-2. The second electrode of the fourth sub-transistor T5-2 is connected to the first internal node N1.

Configuring the node potential control module 180 to include a third dual-gate transistor results in a smaller leakage current for the node potential control module 180, ensuring that the potential of the first internal node N1 can be maintained more effectively. This, in turn, ensures that the potential of the control terminal G1 of the driving module 110 is maintained more effectively, improving the display effect and allowing the pixel circuit to maintain good display performance even at low refresh frequencies, achieving wide-frequency driving.

In one embodiment, in the fourth dual-gate transistor, the fourth sub-transistor T5-2 is directly connected to the control terminal G1 of the driving module 110. In an embodiment, the channel area of the fourth sub-transistor T5-2 is smaller than the channel area of the third sub-transistor T5-1. With such a configuration, the leakage current of the fourth sub-transistor T5-2 directly connected to the first internal node N1 can be made smaller, allowing the potential of the first internal node N1 to be maintained more effectively. This further ensures that the potential of the control terminal G1 of the driving module 110 is maintained more effectively, guaranteeing the display effect and achieving wide-frequency driving. In some embodiments, the channel area of the fourth sub-transistor T5-2 is smaller than the channel area of other transistors in the same pixel circuit.

Continuing to refer to FIG. 8, FIG. 9, FIG. 18, and FIG. 19, in an embodiment, the node potential control module 180 further includes a fifth capacitor C5. The first terminal of the fifth capacitor C5 is connected to a fifth fixed voltage V5, and the second terminal of the fifth capacitor C5 is connected to the second electrode of the third sub-transistor T5-1. With such a configuration, when the high and low levels of the first control signal transition, the potential of the intermediate node between the third sub-transistor T5-1 and the fourth sub-transistor T5-2 will not be affected. This ensures that when the fifth transistor T5 is turned off, the intermediate node between the third sub-transistor T5-1 and the fourth sub-transistor T5-2 can be well maintained, further ensuring that the leakage current of the fifth transistor T5 is small and guaranteeing the display effect during low-frequency display.

In an embodiment, the fifth fixed voltage V5 is equal to one of the first fixed voltage V1, the first power supply voltage, the second power supply voltage, the second fixed voltage V2, and the first initialization voltage, reducing the number of wirings in the display panel.

Referring to FIG. 8, FIG. 9, FIG. 18, and FIG. 19, the case is shown where the first terminal of the driving module 110 is indirectly connected to the predetermined fixed voltage V0 and the node potential control module 180 includes a dual-gate transistor. In other embodiments, for the pixel circuit structures shown in FIG. 4, FIG. 6, and FIG. 7 where the first terminal of the driving module 110 is directly connected to the predetermined fixed voltage V0, the node potential control module 180 may also have the structure of the node potential control module 180 shown in FIG. 8, FIG. 9, FIG. 18, and FIG. 19.

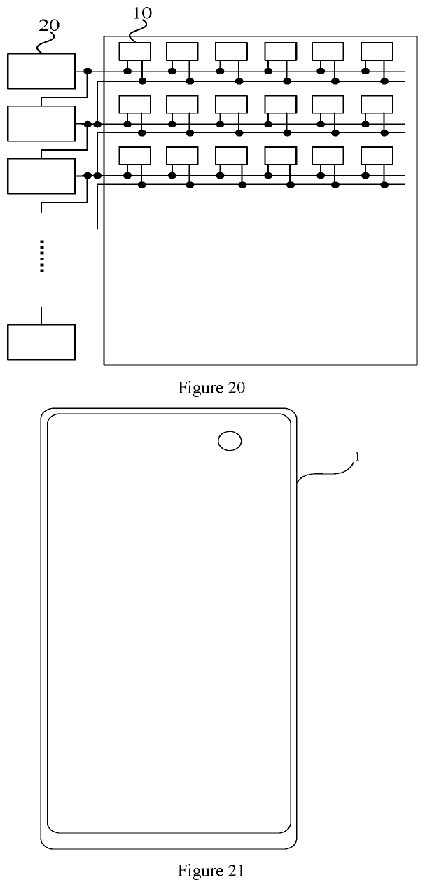

Embodiments of the present disclosure also provide an array substrate. FIG. 20 is a schematic structural diagram of an array substrate provided by an embodiment of the present disclosure. Referring to FIG. 20, in an embodiment, the array substrate includes the pixel circuit 10 according to any of the above embodiments of the present disclosure, and possesses the beneficial effects of the pixel circuit 10 according to any of the above embodiments of the present disclosure, which will not be repeated here.

Continuing to refer to FIG. 20, in an embodiment, the array substrate further includes a first scan driving circuit. The first scan driving circuit includes multiple cascaded first shift registers 20. For the pixel circuit 10 shown in FIG. 2, FIG. 4, FIG. 6, and FIG. 7, the first terminal of the driving module is connected to the first power line, the predetermined fixed voltage is equal to the first power supply voltage on the first power line, the control terminal of the compensation module is connected to the second scan signal line, the first terminal of the compensation module is connected to the second terminal of the driving module, and the second terminal of the compensation module is connected to the first terminal of the driving module. The first terminal of the first initialization module is connected to the first initialization signal line, and the second terminal of the first initialization module is connected to the control terminal of the driving module. The compensation module and the first initialization module of the same pixel circuit 10 are connected to different stages of first shift registers 20 in the first scan driving circuit.

In an embodiment, in the same pixel circuit 10, the first shift register 20 connected to the compensation module is n stages after the first shift register 20 connected to the first initialization module, where n is a positive integer greater than or equal to 1. In one embodiment, the number of scan driving circuits for driving the pixel circuit 10 can be reduced, which is beneficial for achieving a narrow bezel.

For the pixel circuit 10 shown in FIGS. 3, 5, 8, 9, 18, and 19, the pixel circuit 10 further includes a first light emission control module and a second initialization module. The control terminal of the first light emission control module is connected to a first light emission control signal line, the first terminal of the first light emission control module is connected to a first power line, and the second terminal of the first light emission control module is connected to the first terminal of the driving module. The first light emission control module is configured to conduct in response to the active level of the first light emission control signal during the light emission phase.

The control terminal of the second initialization module is connected to a second scan signal line, the first terminal of the second initialization module is connected to a second power line, and the second terminal of the second initialization module is connected to the first terminal of the driving module. The second initialization module is configured to transmit the second power voltage on the second power line to the first terminal of the driving module in response to the active level of the second scan signal on the second scan signal line during the compensation phase. The fixed voltage is set equal to the second power voltage. The compensation module is configured to transmit voltage information related to the threshold voltage of the driving module to the control terminal of the driving module based on the second power voltage during the compensation phase.

In an embodiment, in the same pixel circuit 10, the first shift register 20 connected to the data writing module is n stages after the first shift register 20 connected to the first initialization module. In one embodiment, on one hand, the number of scan driving circuits for driving the pixel circuit 10 can be reduced, which is beneficial for achieving a narrow bezel. In some embodiments, in the same pixel circuit 10, the first shift register 20 connected to the data writing module is m stages after the first shift register 20 connected to the first initialization module, where m is a positive integer greater than or equal to 2.

In one embodiment, there can be a time interval between the data writing phase and the first initialization phase of the pixel circuit 10, while the time interval between the data writing phase and the light emission phase is relatively short. This ensures that the data voltage is stored at the first terminal of the storage coupling module for a shorter duration, avoiding inaccuracies in the data voltage due to leakage current in the transistor of the data writing module, which could affect the display effect.

FIG. 18 shows a situation where the same pixel circuit is connected to two adjacent stages of first shift registers, respectively.

The embodiments of the present disclosure also provide a display panel. FIG. 21 is a schematic structural diagram of a display panel provided by an embodiment of the present disclosure. The display panel 1 includes the array substrate according to any of the above embodiments of the present disclosure. The display panel can be applied in products such as televisions, laptops, desktop monitors, tablets, digital cameras, smart bracelets, smart glasses, vehicle-mounted displays, medical devices, industrial control equipment, and touch interaction terminals. The embodiments of the present disclosure impose no special limitations in this regard. The various forms of processes shown above can be used, with steps reordered, added, or deleted. In an embodiment, the steps described in the present disclosure can be executed in parallel, sequentially, or in different orders, as long as the desired results of the embodiments of the present disclosure can be achieved. No limitations are imposed herein.

The above specific implementations do not constitute limitations on the scope of protection of the present disclosure. It should be understood that various modifications, combinations, sub-combinations, and substitutions can be made according to design requirements and other factors. Any modifications, equivalent replacements, and improvements made within the spirit and principles of the present disclosure shall be included within the scope of protection of the present disclosure.

1. A pixel circuit, comprising:
a driving module, a first terminal of the driving module being configured to receive a predetermined fixed voltage, and a second terminal of the driving module outputting a driving current;
a first initialization module, a first terminal of the first initialization module being connected to a first initialization signal line, a second terminal of the first initialization module being connected to a control terminal of the driving module, and the first initialization module being configured, in a first initialization phase, to transmit a first initialization voltage from the first initialization signal line to the control terminal of the driving module, a voltage value of the predetermined fixed voltage being greater than a voltage value of the first initialization voltage, a voltage at the control terminal of the driving module being lower than a voltage at the first terminal of the driving module;
a compensation module, connected between the second terminal of the driving module and the control terminal of the driving module, and configured, in a compensation phase, to transmit voltage information related to a threshold voltage of the driving module to the control terminal of the driving module;
wherein the first initialization phase precedes the compensation phase.

2. The pixel circuit according to claim 1, wherein the first terminal of the driving module is connected to a first power line, and the predetermined fixed voltage is equal to a first power voltage on the first power line;
a control terminal of the first initialization module is connected to a first scan signal line, and is configured, in the first initialization phase, to transmit the first initialization voltage to the control terminal of the driving module, in response to a first scan signal on the first scan signal line;
a control terminal of the compensation module is connected to a second scan signal line, a first terminal of the compensation module is connected to the second terminal of the driving module, a second terminal of the compensation module is connected to the control terminal of the driving module, and the compensation module is configured, in the compensation phase, to transmit voltage information related to the threshold voltage of the driving module to the control terminal of the driving module, based on the first power voltage.

3. The pixel circuit according to claim 1, further comprising a first light emission control module and a second initialization module,
a control terminal of the first light emission control module is connected to a first light emission control signal line, a first terminal of the first light emission control module is connected to a first power line, a second terminal of the first light emission control module is connected to the first terminal of the driving module, and the first light emission control module is configured, in a light emission phase, to be turned on in response to an active level of a first light emission control signal on the first light emission control signal line;
a control terminal of the second initialization module is connected to a second scan signal line, a first terminal of the second initialization module is connected to a second power line, a second terminal of the second initialization module is connected to the first terminal of the driving module; and the second initialization module is configured, in the compensation phase, to transmit a second power voltage from the second power line to the first terminal of the driving module in response to an active level of a second scan signal on the second scan signal line;
the compensation module is configured, in the compensation phase, to transmit voltage information related to the threshold voltage of the driving module to the control terminal of the driving module, based on the second power voltage; and
a control terminal of the first initialization module is connected to a first scan signal line, and is configured, in the first initialization phase, to transmit the first initialization voltage to the control terminal of the driving module, in response to a first scan signal on the first scan signal line.

4. The pixel circuit according to claim 3, further comprising:
a data writing module, connected to a data line and a first fixed voltage line;
a storage coupling module, a first terminal of the storage coupling module being connected to the data writing module, and a second terminal of the storage coupling module being connected to the control terminal of the driving module; and
a node potential control module,
wherein the data writing module is configured, in a data writing phase, to transmit a data voltage from the data line to the first terminal of the storage coupling module, and is configured, in a light emission phase, to transmit a first fixed voltage from the first fixed voltage line to the first terminal of the storage coupling module;
the storage coupling module is configured, in the light emission phase, to couple a voltage containing data voltage information from the first terminal of the storage coupling module to the control terminal of the driving module, and the driving module is configured, in the light emission phase, to generate a driving current based on a voltage at the control terminal of the driving module;
the node potential control module is connected to a first internal node of the storage coupling module, wherein a control terminal of the node potential control module is connected to a first control signal line, and the node potential control module is configured, under a control of a first control signal on the first control signal line, to transmit a second fixed voltage to the first internal node during the initialization phase, the compensation phase, and the data writing phase.

5. The pixel circuit according to claim 4, wherein the storage coupling module comprises a first storage coupling unit and a second storage coupling unit, a first terminal of the first storage coupling unit serves as a first terminal of the storage coupling module, a second terminal of the first storage coupling unit is connected to a first terminal of the second storage coupling unit at the first internal node, and a second terminal of the second storage coupling unit is electrically connected to a control terminal of the driving module;
the first storage coupling unit comprises a first capacitor; the second storage coupling unit comprises a second capacitor; a first terminal of the first capacitor serves as the first terminal of the first storage coupling unit, and a second terminal of the first capacitor serves as the second terminal of the first storage coupling unit; a first terminal of the second capacitor serves as the first terminal of the second storage coupling unit, and a second terminal of the second capacitor serves as the second terminal of the second storage coupling unit.

6. The pixel circuit according to claim 4, wherein the data writing module comprises a data writing unit and a writing control unit, a first terminal of the data writing unit is connected to a data line, a first terminal of the writing control unit is connected to the first fixed voltage line, a control terminal of the writing control unit is connected to a second light emission control signal line, a second terminal of the data writing unit and a second terminal of the writing control unit are respectively connected to the first terminal of the storage coupling module; the data writing unit is configured to transmit a data voltage to the first terminal of the storage coupling module during a data writing phase, and the writing control unit is configured to, during a light emission phase, transmit a first fixed voltage to the first terminal of the storage coupling module in response to a second light emission control signal on the second light emission control signal line;
the pixel circuit further comprises a second light emission control module, a control terminal of the second light emission control module is connected to the first light emission control signal line, a first terminal of the second light emission control module is connected to a second terminal of the driving module, and a second terminal of the second light emission control module is configured to be connected to a light emission module; the second light emission control module is configured to, during the light emission phase, be turned on in response to an active level of the first light emission control signal on the first light emission control signal line, and, during periods other than the light emission phase, be turned off in response to an inactive level of the first light emission control signal.

7. The pixel circuit according to claim 6, wherein, within one frame, an active level of the first control signal is within a period of an inactive level of the second light emission control signal; the node potential control module is configured to be turned on in response to the active level of the first control signal;
within one frame, a start time of the active level of the first control signal is after a start time of the inactive level of the second light emission control signal, and an end time of the active level of the first control signal is before an end time of the inactive level of the second light emission control signal;
a frequency of the first light emission control signal is greater than or equal to a frequency of the second light emission control signal; and
the pixel circuit further comprises a third initialization module, the third initialization module is configured to transmit a second initialization voltage to the second terminal of the second light emission control module during the first initialization phase, the compensation phase, or the data writing phase.

8. The pixel circuit according to claim 6, wherein a first terminal of the driving module is connected to a first power line, the predetermined fixed voltage is equal to a first power voltage on the first power line;
a control terminal of the data writing unit is connected to a third scan signal line, the data writing unit is configured to, during the data writing phase, transmit the data voltage to the first terminal of the storage coupling module in response to an active level of a third scan signal on the third scan signal line;
within one frame, an active level of the third scan signal is after an active level of the second scan signal;
a pulse width duration of the active level of the third scan signal is less than a pulse width duration of the active level of the second scan signal;
within one frame, the active level of the second scan signal is after an active level of the first scan signal;
the active level of the second scan signal and the active level of the first scan signal are the same, and the pulse width duration of the active level of the second scan signal is the same as the pulse width duration of the active level of the first scan signal;
the first light emission control signal line is multiplexed as the second light emission control signal line.

9. The pixel circuit according to claim 6, wherein a first terminal of the driving module is connected to a first power line, the predetermined fixed voltage is equal to a first power voltage on the first power line;
a control terminal of the data writing unit is connected to the first scan signal line, and is configured to, during the data writing phase, transmit the data voltage to the first terminal of the storage coupling module in response to an active level of a first scan signal on the first scan signal line, the data writing phase and the first initialization phase are performed simultaneously;
or, the control terminal of the data writing unit is connected to the second scan signal line, and is configured to, during the data writing phase, transmit the data voltage to the first terminal of the storage coupling module in response to an active level of a second scan signal on the second scan signal line, the data writing phase and the compensation phase are performed simultaneously.

10. The pixel circuit according to claim 9, wherein within one frame, an active level of the second scan signal is after an active level of the first scan signal;
the active level of the second scan signal and the active level of the first scan signal are the same, and a pulse width duration of the active level of the second scan signal is the same as a pulse width duration of the active level of the first scan signal;
the first light emission control signal line is multiplexed as the second light emission control signal line.

11. The pixel circuit according to claim 6, wherein a first terminal of the driving module is connected to a first power line, and the predetermined fixed voltage is equal to a first power voltage on the first power line;
a first terminal of the compensation module is electrically connected to a second terminal of the driving module, a second terminal of the compensation module is electrically connected to a control terminal of the driving module, and the second terminal of the compensation module is further electrically connected to a second terminal of the first initialization module.

12. The pixel circuit according to claim 4, wherein a first terminal of the driving module is connected to a first power line, and the first fixed voltage is not equal to the first power voltage; or, the pixel circuit further comprises a first light emission control module and a second initialization module, a control terminal of the first light emission control module is connected to a first light emission control signal line, a first terminal of the first light emission control module is connected to the first power line, a second terminal of the first light emission control module is connected to the first terminal of the driving module; a control terminal of the second initialization module is connected to a second scan signal line, a first terminal of the second initialization module is connected to a second power line, a second terminal of the second initialization module is connected to the first terminal of the driving module; the first fixed voltage is equal to the first power voltage.

13. The pixel circuit according to claim 6, wherein the pixel circuit further comprises a first light emission control module and a second initialization module, a control terminal of the first light emission control module is connected to a first light emission control signal line, a first terminal of the first light emission control module is connected to a first power line, a second terminal of the first light emission control module is connected to the first terminal of the driving module; a control terminal of the second initialization module is connected to a second scan signal line, a first terminal of the second initialization module is connected to a second power line, a second terminal of the second initialization module is connected to the first terminal of the driving module; the compensation module comprises a first compensation unit, a control terminal of the first compensation unit is connected to the first control signal line, and the first compensation unit is connected between the control terminal of the driving module and the second terminal of the driving module;
the first compensation unit is configured to, in the first initialization phase, be turned on in response to an active level of the first control signal to transmit the first initialization voltage to the control terminal of the driving module; and in the compensation phase, be turned on in response to the active level of the first control signal to transmit voltage information related to a threshold voltage of the driving module to the control terminal of the driving module; and in the data writing phase, be turned on in response to the active level of the first control signal; the first initialization module is connected to the control terminal of the driving module through the first compensation unit;
the second power voltage is greater than or equal to the first power voltage on the first power line;
the first power line is multiplexed as the second power line;
one display frame at least comprises a writing frame, the writing frame comprises the first initialization phase, the compensation phase, the data writing phase, and a light emission phase;
the display frame further comprises a holding frame, the holding frame comprises a first characteristic improvement phase and the light emission phase, and
the second initialization module is further configured to, in the first characteristic improvement phase, transmit the second power voltage to the first terminal of the driving module;
in the holding frame, the first control signal maintains an inactive level;
before the first initialization phase of the writing frame and before the first characteristic improvement phase of the holding frame, there is a second characteristic improvement phase, and the second initialization module is further configured to, in the second characteristic improvement phase, in response to an active level of a second scan signal on the second scan signal line, transmit the second power voltage on the second power line to the first terminal of the driving module;
the compensation module is further configured to, in the second characteristic improvement phase of the writing frame, charge the control terminal of the driving module according to the second power voltage.

14. The pixel circuit according to claim 13, wherein the compensation module further comprises a second compensation unit, a control terminal of the second compensation unit is connected to the second scan signal line, a first terminal of the second compensation unit is connected to the second terminal of the driving module, a second terminal of the second compensation unit is connected to the first terminal of the first compensation unit, and a second terminal of the first compensation unit is connected to the control terminal of the driving module; the second compensation unit is configured to, in the compensation phase, be turned on in response to the active level of the second scan signal to transmit voltage information related to the threshold voltage of the driving module to the control terminal of the driving module through the first compensation unit;
the second compensation unit is further configured to, in the second characteristic improvement phase, be turned on in response to the active level of the second scan signal to charge the control terminal of the driving module through the first compensation unit in the second characteristic improvement phase of the writing frame;
the second compensation unit is further configured to, in the first initialization phase, turn off in response to an inactive level of the second scan signal;
the second compensation unit is further configured to, in the data writing phase, turn off in response to the inactive level of the second scan signal.

15. The pixel circuit according to claim 14, wherein the pixel circuit further comprises a storage holding module, the storage holding module is connected to the first terminal of the driving module and is configured to store and hold a voltage at the first terminal of the driving module;
the storage holding module comprises a third capacitor, a first terminal of the third capacitor receives a third fixed voltage, and a second terminal of the third capacitor is connected to the first terminal of the driving module;
the third fixed voltage is equal to one of the first fixed voltage, the first power voltage, the second power voltage, the second fixed voltage, and the first initialization voltage.

16. The pixel circuit according to claim 13, wherein the first compensation unit comprises a third dual-gate transistor, the third dual-gate transistor comprises a first sub-transistor and a second sub-transistor, a gate of the first sub-transistor and a gate of the second sub-transistor are connected to the first control signal line, a first electrode of the first sub-transistor is connected to the first initialization module, a second electrode of the first sub-transistor is connected to a first electrode of the second sub-transistor, and a second electrode of the second sub-transistor is connected to a control terminal of the driving module;
a channel area of the second sub-transistor is smaller than a channel area of the first sub-transistor;
the channel area of the second sub-transistor is smaller than a channel area of another transistor in the same pixel circuit.

17. The pixel circuit according to claim 16, wherein the first compensation unit further comprises a fourth capacitor, a first terminal of the fourth capacitor is connected to a fourth fixed voltage, and a second terminal of the fourth capacitor is connected to the second electrode of the first sub-transistor;
the fourth fixed voltage is equal to one of the first fixed voltage, the first power supply voltage, the second power supply voltage, the second fixed voltage, and the first initialization voltage.

18. The pixel circuit according to claim 13, wherein a control terminal of the data writing unit is connected to a third scan signal line, and the data writing unit is configured to, in the data writing phase, be turned on in response to an active level of a third scan signal on the third scan signal line, to transmit the data voltage to a first terminal of the storage coupling module; the third scan signal maintains an inactive level during the hold frame;
the active level of the third scan signal is the same as an active level of the first scan signal, and a pulse width duration of the active level of the third scan signal is the same as a pulse width duration of the active level of the first scan signal;
the active level of the third scan signal overlaps with an active level of the second scan signal corresponding to the compensation phase;
the pulse width duration of the active level of the third scan signal is less than a pulse width duration of the active level of the second scan signal;
a frequency of the second light emission control signal is equal to a frequency of the third scan signal, or,
the control terminal of the data writing unit is connected to the first scan signal line, and the data writing module is configured to, in the data writing phase, be turned on in response to the active level of the first scan signal, to transmit the data voltage to the first terminal of the coupling module; during the hold frame, the first scan signal maintains the inactive level;
the pulse width duration of the active level of the second scan signal is greater than the pulse width duration of the active level of the first scan signal;
the frequency of the second light emission control signal is equal to a frequency of the first scan signal;
during the hold frame, the second light emission control signal maintains the inactive level,
the writing control unit is configured to, in a light emission phase of the writing frame, in response to a second light emission control signal on the second light emission control signal line, transmit the first fixed voltage to the first terminal of the storage coupling module.

19. The pixel circuit according to claim 4, wherein the node potential control module comprises a fourth dual-gate transistor, the fourth dual-gate transistor comprises a third sub-transistor and a fourth sub-transistor, a gate of the third sub-transistor and a gate of the fourth sub-transistor are connected to the first control signal line, a first electrode of the third sub-transistor is connected to the second fixed voltage line, a second electrode of the third sub-transistor is connected to a first electrode of the fourth sub-transistor, and a second electrode of the fourth sub-transistor is connected to the first internal node,
a channel area of the fourth sub-transistor is smaller than a channel area of the third sub-transistor,
the channel area of the fourth sub-transistor is smaller than a channel area of another transistor in the same pixel circuit,
the node potential control module further comprises a fifth capacitor, a first terminal of the fifth capacitor is connected to a fifth fixed voltage, and a second terminal of the fifth capacitor is connected to the second electrode of the third sub-transistor;
the fifth fixed voltage is equal to one of the first fixed voltage, the first power supply voltage, the second power supply voltage, the second fixed voltage, and the first initialization voltage.

20. An array substrate, comprising:
the pixel circuit according to claim 1, and
a first scan driving circuit, comprising a plurality of cascaded first shift registers;
wherein a first terminal of the driving module is connected to a first power line, the predetermined fixed voltage is equal to a first power voltage on the first power line;
a control terminal of the compensation module is connected to a second scan signal line, a first terminal of the compensation module is connected to a second terminal of the driving module, and a second terminal of the compensation module is connected to the first terminal of the driving module;
a first terminal of the first initialization module is connected to a first initialization signal line, and a second terminal of the first initialization module is connected to the control terminal of the driving module;
the compensation module and the first initialization module of the same pixel circuit are connected to different stages of first shift registers in the first scan driving circuit;
in the same pixel circuit, the first shift register connected to the compensation module is n stages after the first shift register connected to the first initialization module, where n is a positive integer greater than or equal to 1; or,
the pixel circuit further comprises a first light emission control module and a second initialization module, a control terminal of the first light emission control module is connected to a first light emission control signal line, a first terminal of the first light emission control module is connected to the first power line, a second terminal of the first light emission control module is connected to the first terminal of the driving module, and the first light emission control module is configured to be turned on in response to an active level of the first light emission control signal during a light emission phase;
a control terminal of the second initialization module is connected to a second scan signal line, a first terminal of the second initialization module is connected to a second power line, a second terminal of the second initialization module is connected to the first terminal of the driving module; the second initialization module is configured to, during a compensation phase, in response to an active level of a second scan signal on the second scan signal line, transmit a second power voltage on the second power line to the first terminal of the driving module;
the predetermined fixed voltage is equal to the second power voltage;
the compensation module is configured to, during the compensation phase, transmit voltage information related to a threshold voltage of the driving module to the control terminal of the driving module according to the second power voltage;
in the same pixel circuit, the first shift register connected to the data writing module is n stages after the first shift register connected to the first initialization module, where n is a positive integer greater than or equal to 1;
in the same pixel circuit, the first shift register connected to the data writing module is m stages after the first shift register connected to the first initialization module, where m is a positive integer greater than or equal to 2.
